(19) United States
(12) Patent Application Publication
(10) Pub. No.: US 2025/0168531 A1
(43) Pub. Date: May 22, 2025

(54) IMAGE SENSOR AND OPERATING METHOD OF IMAGE SENSOR

(71) Applicant: Samsung Electronics Co., Ltd., Suwon-si (KR)

(72) Inventors: Hyukbin Kwon, Suwon-si (KR); Joosung Moon, Suwon-si (KR); Sungjae Byun, Suwon-si (KR); Minwoong Seo, Suwon-si (KR)

(21) Appl. No.: 18/950,632

(22) Filed: Nov. 18, 2024

(30) Foreign Application Priority Data
Nov. 20, 2023 (KR) 10-2023-0160311
May 28, 2024 (KR) 10-2024-0069517

(51) Int. Cl. H04N 25/77; H02M 3/07; H04N 25/709

(52) U.S. Cl. CPC H04N 25/77; H04N 25/709; H02M 3/07

(57) ABSTRACT

An image sensor including a pixel array in which a plurality of pixels are arranged in rows and columns, a voltage generator configured to generate a plurality of voltages including a first power supply voltage and a second power supply voltage. The first power supply voltage and the second power supply voltage have a same voltage level. The image sensor further including a row driver configured to generate a pixel control signal provided to the plurality of pixels based on the first power supply voltage during a first period and generate the pixel control signal based on the second power supply voltage during a second period after the first period.

### CROSS-REFERENCE TO RELATED APPLICATION

This application is based on and claims priority under 35 USC § 119 to Korean Patent Application Nos. 10-2023-0160311, filed on Nov. 20, 2023, and 10-2024-0069517, filed on May 28, 2024, in the Korean Intellectual Property Office, the disclosures of which are incorporated by reference herein in their entirety.

### BACKGROUND

Aspects of inventive concept relate to an image sensor, and more particularly, to an image sensor including a row driver capable of supporting global shutter-type driving and rolling shutter-type driving and an operating method of the image sensor.

As mobile devices have become smaller, various functions have been integrated into mobile devices. The functions and performance of image sensors included in mobile devices have a significant impact on the characteristics of mobile devices. Technology to reduce image sensor power consumption and image sensor size has become increasingly important.

An image sensor may determine the amount of photocharge, which is the basis for an electrical signal, by adjusting an exposure time. Image sensors may control exposure time using a rolling shutter method and a global shutter method. The global shutter method is a method that controls the accumulation time of photocharges equally for different rows of the pixel array. When the image sensor operates according to the global shutter method, a row driver that drives a pixel array has to drive multiple rows of the pixel array simultaneously, and accordingly, a driving load may increase.

### SUMMARY

Aspects of the inventive concept provide an image sensor including a row driver that generates a pixel control signal using a plurality of power supply voltages so that the pixel control signal simultaneously provided to a plurality of rows of a plurality of pixels of a pixel array is maintained to be the same over time, and an operating method of the image sensor.

According to an aspect of the inventive concept, there is provided an image sensor including a pixel array in which a plurality of pixels are arranged in rows and columns, a voltage generator configured to generate a plurality of voltages including a first power supply voltage and a second power supply voltage, wherein the first power supply voltage and the second power supply voltage have a same voltage level, and a row driver configured to generate a pixel control signal provided to the plurality of pixels based on the first power supply voltage during a first period and generate the pixel control signal based on the second power supply voltage during a second period after the first period.

According to another aspect of the inventive concept, there is provided an image sensor including a pixel array including a plurality of pixels arranged in rows and columns, a voltage generating circuit configured to generate a first power supply voltage, a second power supply voltage, a third power supply voltage, and a fourth power supply voltage, wherein the first power supply voltage and the second power supply voltage have a first voltage level, and the third power supply voltage and the fourth power supply voltage have a second voltage level that is lower than the first voltage level, and a row driver configured to generate a pixel control signal provided to the plurality of pixels based on the first power supply voltage and the third power supply voltage during a first period and generate a pixel control signal provided to the plurality of pixels based on the second power supply voltage and the fourth power supply voltage during a second period after the first period.

According to another aspect of the inventive concept, there is provided an operating method of an image sensor, which includes a pixel array including a plurality of pixels, a row driver driving the pixel array, and a voltage generating circuit providing a power supply voltage to the row driver, including generating, by the voltage generating circuit, a first power supply voltage and a second power supply voltage, generating, by the row driver, a pixel control signal provided to the plurality of pixels corresponding to a plurality of rows of the pixel array based on the first power supply voltage during a first period, and generating, by the row driver, the pixel control signal based on the second power supply voltage during a second period after the first period.

### BRIEF DESCRIPTION OF THE DRAWINGS

Embodiments will be more clearly understood from the following detailed description taken in conjunction with the accompanying drawings in which:

FIG. 1 is a block diagram illustrating an image sensor according to an embodiment;

FIG. 2 illustrates a row driver and a voltage generator according to an embodiment;

FIG. 3A illustrates an operation of an image sensor based on a global shutter method according to embodiment, and FIG. 3B illustrates an operation of an image sensor based on a rolling shutter method according to an exemplary embodiment of the present disclosure;

FIGS. 4A and 4B are circuit diagrams illustrating pixels provided in an image sensor according to an embodiment;

FIG. 5 is a timing diagram illustrating pixel control signals and a ramp signal provided to a pixel when an image sensor operates in a global shutter mode according to an embodiment;

FIG. 6 is a circuit diagram illustrating another voltage generator according to an embodiment;

FIG. 7 illustrates a row driver according to an embodiment;

FIG. 8 is a circuit diagram illustrating a driver according to an embodiment;

FIG. 9 illustrates a timing diagram of a row driver according to an embodiment;

FIG. 10 is a block diagram illustrating a voltage generator according to an embodiment;

FIG. 11 illustrates a row driver according to an embodiment;

FIG. 12A is a timing diagram of a row driver according to an embodiment, and FIG. 12B is a timing diagram of a row driver according to a comparative example;

FIG. 13 is a timing diagram of a row driver according to an embodiment;

FIG. 14A is a timing diagram of an operation of an image sensor according to a comparative example, and FIG. 14B is a timing diagram of an operation of an image sensor according to an example of the inventive concept;

FIG. 15 is a diagram illustrating an operating method of an image sensor according to an embodiment; and

FIG. 16 is a block diagram illustrating an electronic device including an image sensor according to an embodiment.

### DETAILED DESCRIPTION OF THE EMBODIMENTS

Hereinafter, embodiments are described in detail with reference to the attached drawings.

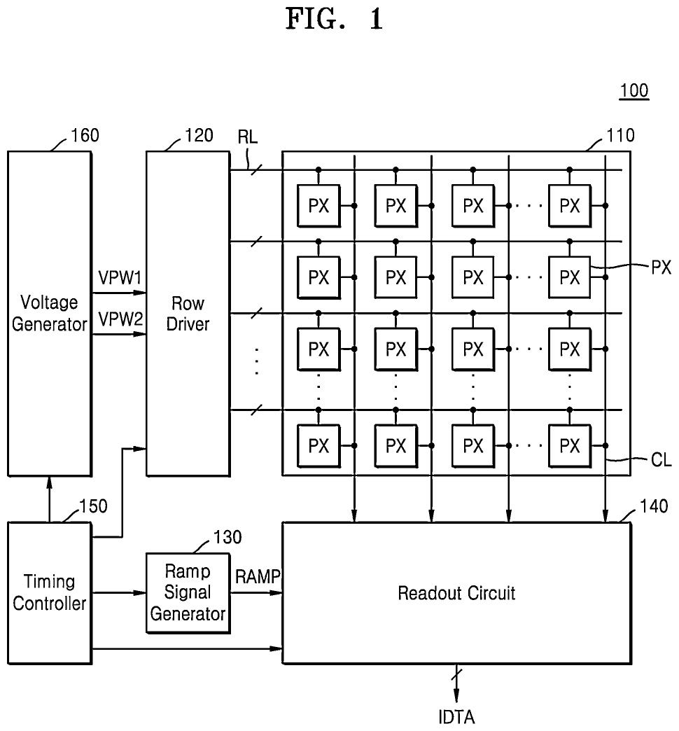

FIG. 1 is a block diagram illustrating an image sensor 100 according to an embodiment.

Referring to FIG. 1, the image sensor 100 may include a pixel array 110, a row driver 120, a ramp signal generator 130, a readout circuit 140, a timing controller 150, and a voltage generator 160.

The pixel array 110 may include a plurality of row lines RL, a plurality of column lines CL, and a plurality of pixels PX connected to the row lines RL and the column lines CL and arranged in rows and columns. The pixels PX may be active pixel sensors (APS).

Each of the pixels PX may include at least one photoelectric conversion element, and the pixel PX may detect light using the photoelectric conversion element and output an image signal, which is an electrical signal, according to the detected light. For example, the photoelectric conversion element may include a photodiode, a phototransistor, a photogate, or a pinned photodiode.

Each of the pixels PX may detect light in a certain spectral range. For example, the pixels PX may include a red pixel converting light in a red spectral range into an electrical signal, a green pixel converting light in a green spectral range into an electrical signal, and a blue pixel converting light in a blue spectral range into an electrical signal. In an embodiment, the pixels PX may have a color arrangement of a Bayer pattern. However, aspects of the inventive concept are not limited thereto, and the pixels may further include a white pixel. As another example, the pixels may include pixels including a combination of different colors, such as a yellow pixel, a cyan pixel, and a magenta pixel.

A color filter array may be located on top of the pixels PX to transmit light in a certain spectral range, and the color that the pixel PX may detect may be determined according to a color filter located on top of each of the pixels PX. However, aspects of the inventive concept are not limited thereto. In some embodiments, a certain photoelectric conversion element may convert light in a certain wavelength band into an electrical signal depending on the level of an electrical signal applied to the photoelectric conversion element.

In an embodiment, the image sensor 100 may operate according to a global shutter method. According to the global shutter method, the pixels PX corresponding to the rows of the pixel array 110 may be shuttered simultaneously. Here, shuttering refers to removing the charge (e.g., photoelectric charge) remaining in the photoelectric conversion element provided in the pixel PX before the exposure period, and according to aspects of the inventive concept, shuttering is used in the same sense as resetting the photoelectric conversion element. According to the global shutter method, a plurality of pixels PX corresponding to a plurality of rows are simultaneously shuttered, so the exposure start time and exposure period of the pixels PX corresponding to the rows may be the same. After the exposure period, the rows of the pixel array 110 may be sequentially read out.

In an embodiment, the pixels PX may selectively operate according to a global shutter method or a rolling shutter method. According to the rolling shutter method, shuttering may be performed on the pixels PX in row units. For example, after the pixels PX included in a first row of the pixel array 110 perform shuttering, the pixels PX included in the second row may perform shuttering. In this manner, a first row to an n-th row (n is an integer of 2 or greater) of the pixel array 110 may sequentially perform shuttering. Accordingly, the rows of the pixel array 110 may start to be exposed sequentially and be read sequentially.

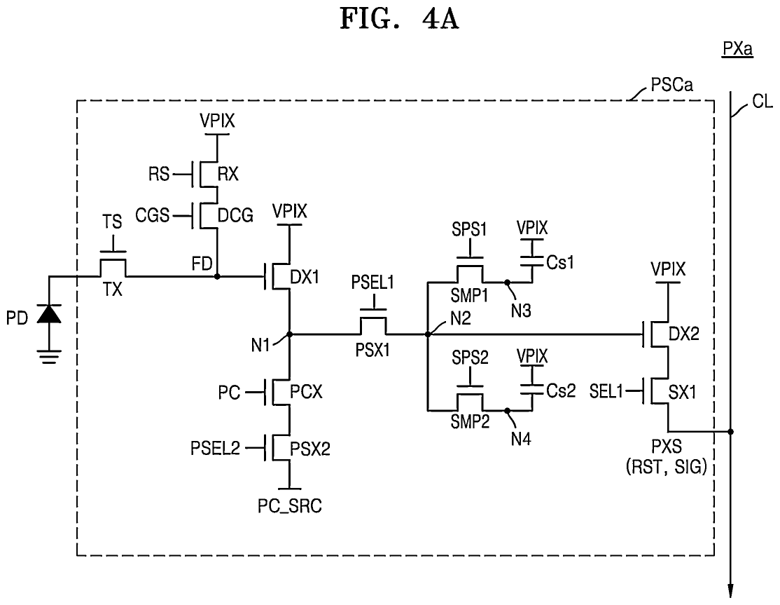

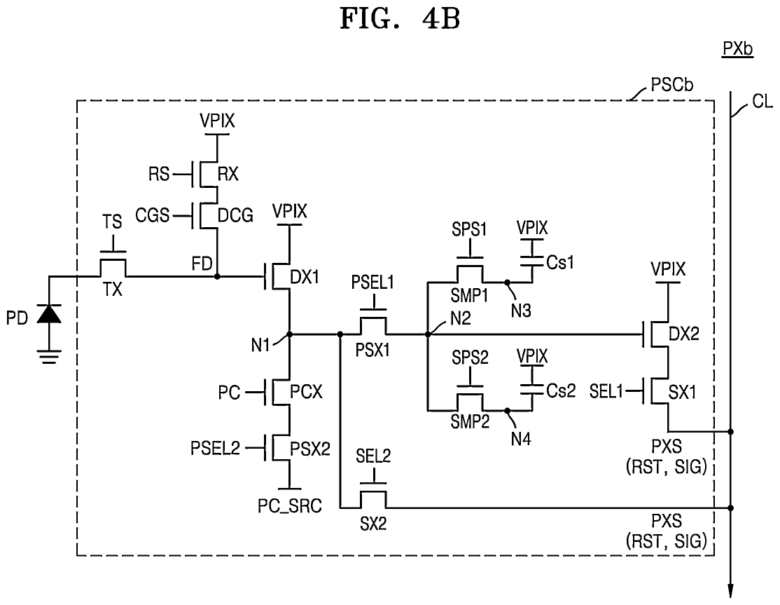

In an embodiment, each of the pixels PX may have a dual conversion gain. Dual conversion gain includes low conversion gain and high conversion gain. Here, a conversion gain refers to a rate at which charges accumulated in a floating diffusion (FD in FIG. 4A) node is converted into voltage. The charge generated in the photoelectric conversion element is transferred to and accumulated in the floating diffusion node FD, and the charges accumulated in the floating diffusion node FD may be converted into voltage according to the conversion gain. Here, the conversion gain may vary depending on capacitance of the floating diffusion node FD. If the capacitance of the floating diffusion node FD increases, the conversion gain may decrease, and if the capacitance decreases, the conversion gain may increase.

In an embodiment, each of the pixels PX may include at least two photodiodes, and the image sensor 100 may perform an autofocus (AF) function based on pixel signals corresponding to photocharges output from the at least two photodiodes.

The row driver 120 drives the pixel array 110 in row units. In an embodiment, the pixel array 110 may include n rows (n is an integer of 2 or greater), and the row driver 120 may include n drivers each corresponding to the n rows of the pixel array 110.

The row driver 120 may decode a row control signal (e.g., an address signal) received from the timing controller 150 and drive the pixel array 110 in response to the decoded row control signal. For example, the row driver 120 may generate a selection signal for selecting one of a plurality of rows. Pixel signals, e.g., pixel voltages, may be output from pixels PX included in the row selected by the selection signal provided from the row driver 120.

The row driver 120 may transmit pixel control signals for output of a pixel signal to the pixel array 110 through the row lines RL, and the pixel PX may operate in response to the pixel control signals to output a pixel signal.

In an embodiment, when the image sensor 100 operates in the global shutter manner, the row driver 120 may simultaneously provide pixel control signals for shuttering and signal dumping to the rows of the pixel array 110. In an embodiment, the pixel control signals may include a transmission control signal (TS in FIG. 4A). However, aspects of the inventive concept are not limited thereto, and the pixel control signals may include various control signals provided to the pixel PX, and the pixel control signals may include sampling control signals, such as a first sampling control signal (SPS1 in FIG. 4A) and a second sampling control signal (SPS2 in FIG. 4A).

In an embodiment, the row driver 120 may generate a pixel control signal based on a plurality of power supply voltages having the same voltage level. For example, the row driver 120 may generate a pixel control signal based on a first power supply voltage VPW1 and a second power supply voltage VPW2 provided from the voltage generator 160 and having the same voltage level. Here, the row driver 120 may generate a pixel control signal based on the first power supply voltage VPW1 during a first period and generate a pixel control signal based on the second power supply voltage VPW2 during a second period after the first period. In this manner, the row driver 120 may generate a pixel control signal by using a plurality of power supply voltages in a time-division manner.

In an embodiment, the row driver 120 may generate a pixel control signal based on the first power supply voltage VPW1 and the second power supply voltage VPW2 or generate a pixel control signal based on the first power supply voltage VPW1, depending on an operation mode. For example, the row driver 120 may generate a pixel control signal based on the first power supply voltage VPW1 and the second power supply voltage VPW2 in a global shutter mode in which the image sensor 100 operates according to the global shutter method and may generate a pixel control signal based on the first power supply voltage VPW1 in a rolling shutter mode in which the image sensor 100 operates according to the rolling shutter method.

The ramp signal generator 130 may generate a ramp signal RAMP (e.g., a ramp voltage) having a level rising or falling at a constant slope under control by the timing controller 150. The ramp signal RAMP may be provided to the readout circuit 140.

The readout circuit 140 may convert pixel signals output from the pixel array 110 into pixel data values, which are digital signals. The readout circuit 1440 may be referred to as an analog-to-digital conversion circuit. The readout circuit 140 may include a plurality of correlated-double sampling circuits, and the correlated-double sampling circuit may compare a pixel signal provided from the pixel array 110 with a ramp signal RAMP provided from the ramp signal generator 130 and generate a pixel data value based on comparison results.

Image data IDATA may be generated based on a plurality of pixel data values generated by the correlated-double sampling circuits. For example, pixel data values corresponding to pixel signals of one frame output from the pixel array 110 may constitute image data IDATA of one frame. In an embodiment, pixel data values may be provided to an image signal processor provided inside or outside the image sensor 100 and image-processed. For example, the image signal processor may perform noise reduction processing, gain adjustment, waveform shaping processing, interpolation processing, white balance processing, gamma processing, edge emphasis processing, etc.

The timing controller 150 may control the operation or operation timing of the row driver 120, the ramp signal generator 130, the readout circuit 140, and the voltage generator 160.

The voltage generator 160 may generate various voltages used in the image sensor 100. In an embodiment, the voltage generator 160 may generate a plurality of power supply voltages including the first power supply voltage VPW1 and the second power supply voltage VPW2 and may provide the power supply voltages to the row driver 120. As described above, the row driver 120 may generate a pixel control signal based on a plurality of power supply voltages. For example, the row driver 120 may generate a pixel control signal (e.g., a transmission control signal) based on the first power supply voltage VPW1 during the first period and generate a pixel control signal based on the second power supply voltage VPW2 during the second period after the first period.

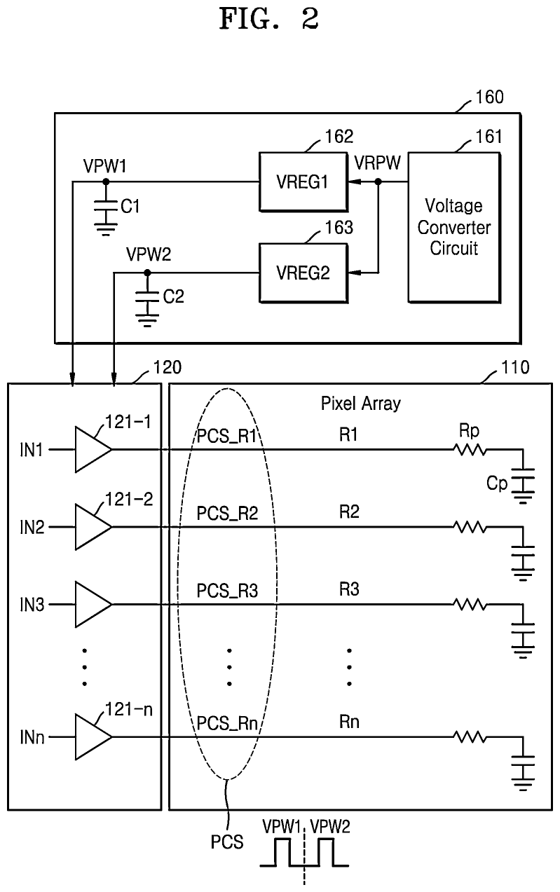

FIG. 2 illustrates the row driver 120 and the voltage generator 160 according to an embodiment. For convenience of description, an equivalent circuit of the pixel array 110 is shown in FIG. 2.

Referring to FIG. 2, the voltage generator 160 may include a voltage converter circuit 161, a first voltage regulator circuit VREG1 162, and a second voltage regulator circuit VREG2 163.

The voltage converter circuit 161 may generate a reference power supply voltage VRPW based on an input voltage. The voltage converter circuit 161 may generate the reference power supply voltage VRPW by boosting the input voltage. For example, the voltage converter circuit 161 may be implemented as a charge pump circuit. However, aspects of the inventive concept are not limited thereto, and the voltage converter circuit 161 may be implemented as various circuits, such as a boost converter, a buck-boost converter, etc.

The first voltage regulator circuit 162 and the second voltage regulator circuit 163 may regulate the reference power supply voltage VRPW to generate the first power supply voltage VPW1 and the second power supply voltage VPW2, respectively. A target level of the first power supply voltage VPW1 may be equal to a target level of the second power supply voltage VPW2. The first power supply voltage VPW1 and the second power supply voltage VPW2 may be provided to the row driver 120.

A first capacitor C1 may be connected to an output terminal of the first voltage regulator circuit 162, and a second capacitor C2 may be connected to an output terminal of the second voltage regulator circuit 163. The first capacitor C1 and the second capacitor C2 may be charged based on the first power supply voltage VPW1 and the second power supply voltage VPW2 and may assist the first power supply voltage VPW1 and the second power supply voltage VPW2 in maintaining a constant level. For example, the first capacitor C1 and the second capacitor C2 may be stabilization capacitors. For example, when a driving load of the first power supply voltage VPW1 is large, the first capacitor C1 may provide charged current to the driving load. Accordingly, a voltage fluctuation of the first power supply voltage VPW1 may decrease. As the capacitance of the first capacitor C1 and the second capacitor C2 increases, the first power supply voltage VPW1 and the second power supply voltage VPW2 may be stably maintained at a constant level.

In an embodiment, the first capacitor C1 and the second capacitor C2 may be external capacitors. For example, the image sensor (100 in FIG. 1) may be integrated into a semiconductor chip, and the first capacitor C1 and the second capacitor C2 may be external to the semiconductor chip. In an embodiment, capacitance of the first capacitor C1 may be the same as capacitance of the second capacitor C2. In an embodiment, the capacitance of the first capacitor C1 may be different from the capacitance of the second capacitor C2. The capacitance of the first capacitor C1 may be greater than the capacitance of the second capacitor C2. For example, the capacitance of the first capacitor C1 may be ten times or more than the capacitance of the second capacitor C2.

The row driver 120 may include a plurality of drivers, e.g., first to n-th drivers 121-1 to 121-n. The first to n-th drivers 121-1 to 121-n may have the same structure. In an embodiment, the pixel array 110 may include n rows R1 to Rn, and the first to n-th drivers 121-1 to 121-n may drive corresponding rows among the n rows R1 to Rn.

The first to n-th drivers 121-1 to 121-n may respectively generate pixel control signals PCS_R1 to PCS_Rn, based on the first power supply voltage VPW1 and the second power supply voltage VPW2, and provide the pixel control signals PCS_R1 to PCS_Rn to a corresponding row. For example, each of the first to n-th drivers 121-1 to 121-n may be implemented as an inverter or a buffer and may invert (or buffer) received input signals IN1 to INn based on the first power supply voltage VPW1 or the second power supply VPW2 to generate the pixel control signals PCS_R1 to PCS_Rn.

When the image sensor (100 in FIG. 1) operates according to the global shutter method, the same pixel control signal PCS may be applied to a plurality of pixels (PX in FIG. 1) provided in the pixel array 110 during a shuttering period and a signal dumping period. For example, the first to n-th drivers 121-1 to 121-n may generate the same pixel control signal PCS and provide the pixel control signal PCS to the rows of the pixel array 110.

As shown, each row of the pixel array 110 may be modeled as a parasitic capacitor Cp and a parasitic resistor Rp. In a case in which the first to n-th drivers 121-1 to 121-n generate the pixel control signal PCS based on a single power supply voltage according to the global shutter method and the same pixel control signal PCS is transmitted to the n rows R1 to Rn of the pixel array 110 simultaneously, when the pixel control signal PCS is toggled, e.g., when the pixel control signal PCS transitions from a low voltage level to a high voltage level or transitions from a high voltage level to a low voltage level, a large amount of voltage drop may occur in the power supply voltage as a driving load of the power supply voltage increases. Accordingly, a voltage settling time until the power supply voltage is restored to a target level may increase, and the characteristics of the image sensor 100 (e.g., deterioration of image quality of image data generated by the image sensor 100) may deteriorate due to fluctuations in the power supply voltage.

For example, when the pixel control signal PCS provided to the n rows R1 to Rn of the pixel array 110 is toggled multiple times (for example, twice or more times) at short time intervals, the pixel control signal PCS may be toggled again during the second period before the power supply voltage is restored to the target level after the voltage drop occurs in the power supply voltage as the pixel control signal PCS is toggled during the first period, and due to the difference between the power supply voltages during the two periods, voltage levels of the pixel control signals PCS during the two periods may be different. In this manner, the pixel control signal PCS may not be maintained to be the same over time, which may cause the characteristics of the image sensor 100 to deteriorate.

However, in the row driver 120 according to an embodiment, because the first to n-th drivers 121-1 to 121-n generate the pixel control signal PCS using the first power supply voltage VPW1 and the second power supply voltage VPW1, which are generated independently, in a time-division manner, the sameness of the pixel control signal PCS may be maintained and the settling time of the power supply voltages may decrease although the pixel control signal PCS is toggled multiple times during a short period.

The first to n-th drivers 121-1 to 121-n may generate the pixel control signal PCS based on the first power supply voltage VPW1 during the first period and generate the pixel control signal PCS based on the second power supply voltage VPW2 during the second period after the first period. The first to n-th drivers 121-1 to 121-n may drive the rows of the pixel array 110 based on the first power supply voltage VPW1 during the first period and drive the rows of the pixel array 110 based on the second power supply voltage VPW2 during the second period. Accordingly, during the first period, the pixel control signal PCS is toggled based on the first power supply voltage VPW1, and during the second period, the pixel control signal PCS is toggled based on the second power supply voltage VPW2. Although a large voltage drop occurs in the first power supply voltage VPW1 as the pixel control signal PCS is toggled during the first period and the rows are driven, the pixel control signal PCS is toggled based on the second power supply voltage VPW2 during the second period, and thus, the voltage drop of the first power supply voltage VPW1 does not affect the pixel control signal PCS during the second period. Accordingly, the temporal sameness of the pixel control signal PCS may be maintained. In addition, because the first power supply voltage VPW1 and the second power supply voltage VPW2 are used in a time-division manner, the driving burden of each of the first power supply voltage VPW1 and the second power supply voltage VPW2 in the entire period including the first period and the second period is reduced, thereby reducing a settling time. Accordingly, even if the image sensor 100 operates in the global shutter manner, deterioration of the characteristics of the image sensor 100 may be reduced or prevented.

When the image sensor 100 operates according to the rolling shutter method, the pixel control signal PCS may be sequentially applied to a plurality of rows of the pixel array 110. For example, the first to n-th drivers 121-1 to 121-n may sequentially generate the pixel control signals PCS and sequentially provide the pixel control signals PCS to the rows of the pixel array 110. Thus, a driving load of the power supply voltage may be reduced.

In an embodiment, when the image sensor 100 operates according to the rolling shutter method, at least one of the first voltage regulator circuit 162 and the second voltage regulator circuit 163 may not operate, and the first to n-th drivers 121-1 to 121-n may sequentially generate the pixel control signals PCS based on the power supply voltage generated by another voltage regulator. For example, when the capacitance of the first capacitor C1 is greater than the capacitance of the second capacitor C2, the first voltage regulator circuit 162 may operate and the second voltage regulator circuit 163 may not operate. The first to n-th drivers 121-1 to 121-n may generate the pixel control signals PCS based on the first power supply voltage VPW1 generated by the first voltage regulator circuit 162.

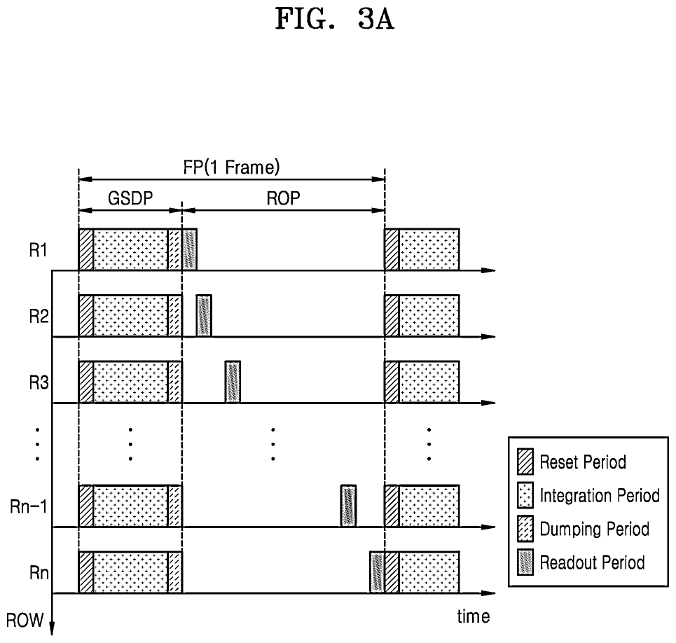

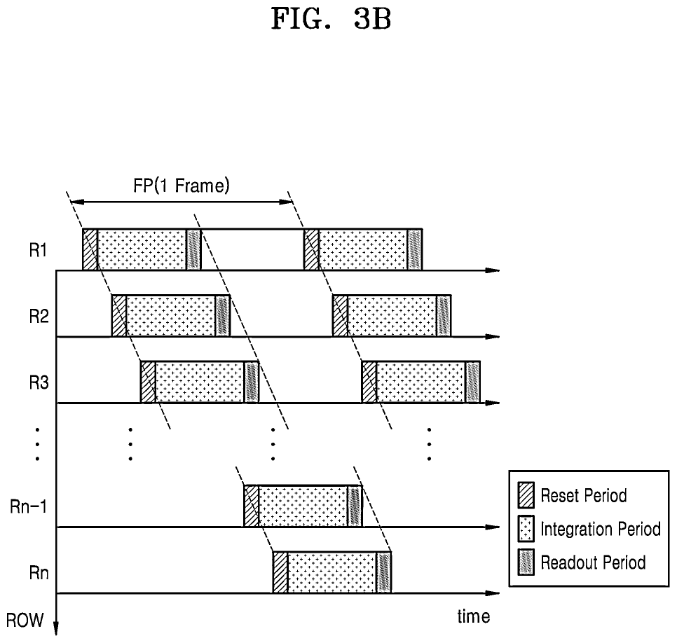

FIGS. 3A and 3B are timing diagrams illustrating an operating method of an image sensor according to an embodiment. FIG. 3A is a timing diagram illustrating an operation of the image sensor 100 based on a global shutter method according to an embodiment, and FIG. 3B is a timing diagram illustrating an operation of the image sensor 100 based on a rolling shutter method according to an embodiment.

Referring to FIGS. 1 and 3A, the image sensor 100 may operate in the global shutter mode. One frame period FP may include a global signal dumping period GSDP and a rolling readout period ROP. The global signal dumping period GSDP may include a reset period, an integration period, and a dumping period, and the rolling readout period ROP may include readout periods for each of rows R1 to Rn of the pixel array (110 in FIG. 1).

The reset period may be referred to as a global reset period and may also be referred to as a shuttering period. During the reset period, a shuttering operation may be performed to remove charges accumulated in a photodiode based on the pixel control signal PCS received by pixels corresponding to the rows. In addition, the pixels may perform a reset operation to remove charges accumulated in the floating diffusion node (FD in FIG. 4A).

During the integration period, photodiodes provided in the pixels PX perform an accumulation operation to generate and accumulate photocharges corresponding to a received optical signal, and during the dumping period DP, the pixels PX may store a reset signal according to a reset level of the floating diffusion node and an image signal corresponding to the photocharges accumulated in the photodiode in at least two capacitors provided therein, respectively.

During the rolling readout period ROP, a readout operation for the rows of the pixel array may be sequentially performed. For example, after a readout operation is performed on the first row R1 of the pixel array 110, a readout operation may be performed on the second row R2. Also, after the readout operation on the second row R2 is performed, a readout operation on the third row R3 may be performed.

Referring to FIGS. 1 and 3B, the image sensor 100 may operate in the rolling shutter mode. One frame period FP may include the reset period (also referred to as a shuttering period), the integration period, and the readout period.

During one frame period FP, the rows (e.g., the first row R1 to the n-th row Rn) of the pixel array 110 may sequentially perform a shuttering operation, an exposure operation, and a readout operation.

As described above, the image sensor 100 according to the present disclosure may operate in the global shutter mode. Alternatively, the image sensor 100 may selectively operate in the global shutter mode or the rolling shutter mode. For example, an electronic device (e.g., an image processing device) equipped with the image sensor 100 may operate in the global shutter mode when capturing a high-speed video and may operate in the rolling shutter mode when capturing a high-quality still image or capturing a low-speed video (in other words, when generating a high-quality image). For example, the image sensor 100 may operate in the rolling shutter mode in a high-illuminance environment and in the global shutter mode in a low-illuminance environment.

FIGS. 4A and 4B are circuit diagrams illustrating pixels PXa and PXb provided in an image sensor according to an embodiment.

Referring to FIG. 4A, the pixel PXa may include a photodiode PD and a pixel signal generating circuit PSCa (or referred to as a pixel circuit). The pixel signal generating circuit PSCa may include a plurality of transistors TX, RX, DCG, DX1, PSX1, PSX2, PCX, SMP1, SMP2, DX2, and SX1, a first sampling capacitor Cs1, and a second sampling capacitor Cs2. Pixel control signals, such as a transmission control signal TS, a reset control signal RS, a gain control signal CGS, a first precharge selection control signal PSEL1, a second precharge selection control signal PSEL2, a precharge signal PC, a first sampling control signal SPS1, a second sampling control signal SPS2, a first selection control signal SEL1, and a second selection control signal SEL2, may be applied to the pixel signal generating circuit PSCa, and at least some of the pixel control signals may be generated based on the first power supply voltage VPW1 and the second power supply voltage VPW2 in the row driver 120. In FIG. 4A, it is illustrated that the pixel PXa includes one photodiode PD and one transmission transistor TX corresponding thereto, but without being limited thereto, the pixel PXa may include a plurality of photodiodes PD and a plurality of transmission transistors TX corresponding thereto. For example, a pixel structure including a plurality of photodiodes may be used to generate a binocular parallax signal for auto-focusing.

The photodiode PD may generate photocharges that vary depending on the intensity of light. The transmission transistor TX may be connected between the photodiode PD and the floating diffusion node FD. The transmission transistor TX may be turned on or off in response to the transmission control signal TS received from the row driver 120. The transmission transistor TX may be turned on and may transmit photocharges generated in the photodiode PD to the floating diffusion node FD. In an embodiment, the transmission control signal TS may be generated based on the first power supply voltage VPW1 and the second power supply voltage VPW2, as described above with reference to FIG. 2.

The reset transistor RX may reset the charges accumulated in the floating diffusion node FD. A pixel voltage VPIX may be applied to a first terminal of the reset transistor RX, and a second terminal of the reset transistor RX may be connected to a first terminal of the conversion gain control transistor DCG. The reset transistor RX may be turned on or off in response to the reset control signal RS received from the row driver 120, and when the reset transistor RX and the conversion gain control transistor DCG are turned on, the charges accumulated in the floating diffusion node FD may be discharged and the floating diffusion node FD may be reset.

The conversion gain control transistor DCG may adjust a conversion gain of the pixel PXa. Here, the conversion gain refers to a rate at which the charges accumulated in the floating diffusion node FD are converted into voltage. The conversion gain may vary depending on capacitance of the floating diffusion node FD. If the capacitance increases, the conversion gain may decrease, and if the capacitance decreases, the conversion gain may increase.

The conversion gain control transistor DCG may be turned on or off in response to the gain control signal CGS, and when the conversion gain control transistor DCG is turned on, capacitance of the floating diffusion node FD may increase, so the conversion gain may decrease, and when the conversion gain transistor DCG is turned off, capacitance of the floating diffusion node FD may decrease, so the conversion gain may increase. Accordingly, the pixel PXa may operate in a high conversion gain (HCG) mode or a low conversion gain (LCG) mode depending on whether the conversion gain control transistor DCG is turned on or off. In other words, the pixel PXa may operate in dual conversion gain modes, and the conversion gain mode may be determined by ON/OFF of the conversion gain control transistor DCG.

The pixel voltage VPIX may be applied to a first terminal of the first driving transistor DX1, and a second terminal of the first driving transistor DX1 may be connected to the first node N1. The first driving transistor DX1 may be a buffer amplifier and may buffer a signal according to the amount of charges accumulated in the floating diffusion node FD. A potential of the floating diffusion node FD may change according to a change in the amount of charges accumulated in the floating diffusion node FD. The first driving transistor DX1 may operate as a source follower and output a voltage corresponding to the voltage of the floating diffusion node FD to the first node N1.

The pixel signal generating circuit PSCa may operate the first driving transistor DX1 and may include a plurality of transistors for precharging the second node N2, e.g., a precharge transistor PCX, a first precharge selection transistor PSX1, and a second precharge selection transistor PSX2.

A first terminal of the precharge transistor PCX may be connected to the first node N1, and a second terminal of the precharge transistor PCX may be connected to a first terminal of the second precharge selection transistor PSX2. A second terminal of the second precharge selection transistor PSX2 may be connected to a precharge source PC_SRC. For example, the precharge source PC_SRC may be a ground voltage. The second precharge selection transistor PSX2 may be turned on or off in response to a second precharge selection control signal PSEL2. The second precharge selection transistor PSX2 may be turned on to provide the precharge source PC_SRC to the second terminal of the precharge transistor PCX. The precharge transistor PCX may operate as a current source and generate a load current according to a precharge control signal PC, and the driving transistor DX1 may operate according to the load current.

A first terminal of the first precharge selection transistor PSX1 may be connected to the first node N1 and the second terminal of the first precharge selection transistor PSX1 may be connected to the second node N2. The second precharge selection transistor PSX1 may be turned on or off in response to the first precharge selection control signal PSEL1 and may be turned on to precharge the second node N2.

In FIG. 4A, the pixel PX is shown as including two precharge selection transistors PSX1 and PSX2, but aspects of the inventive concept are not limited thereto. The two precharge selection transistors PSX1 and PSX2 are transistors for precharging the second node N2 based on a voltage of the first output node N1, however, the pixel PX may include a various number of precharge selection transistors.

The first sampling transistor SMP1, the second sampling transistor PSX2, the first sampling capacitor Cs1, and the second sampling capacitor Cs2 may operate as sampling circuits for sampling a first voltage (e.g., a reset voltage) and a second voltage (e.g., an image voltage) output through the first node N1 when the pixel PXa operates in the global shutter mode.

The first sampling transistor SMP1 may be turned on or off in response to the first sampling control signal SPS1, and may be turned on to connect the first sampling capacitor Cs1 to the second node N2. The second sampling transistor SMP2 may be turned on or off in response to the second sampling control signal SPS2 and may be turned on to connect the second sampling capacitor Cs2 to the second node N2. A reset voltage according to a reset operation may be sampled or an image voltage according to photocharges accumulated in the photodiode PD may be sampled in the first sampling capacitor Cs1 and the second sampling capacitor Cs2, respectively.

In an embodiment, when the pixel PXa has a pixel structure including a plurality of photodiodes, the pixel PXa may further include a third sampling transistor and a third sampling capacitor. A first image voltage corresponding to charges generated in some of the photodiodes may be sampled in the second sampling capacitor Cs2, and a second image voltage corresponding to charges generated in the other of the photodiodes (or in all of the photodiodes) may be sampled in the third sampling capacitor.

During the dumping period (DP in FIG. 3), the first precharge selection transistor PSX1 and the second precharge selection transistor PSX2 may be in an ON state. Here, while the first sampling transistor SMP1 is in an ON state, charges may be accumulated in the first sampling capacitor Cs1 and a reset voltage RST may be sampled (stored) in the first sampling capacitor Cs1. Thereafter, charges may be accumulated in the second sampling capacitor Cs2 while the second sampling transistor SMP2 is in an ON state, and an image voltage SIG may be sampled (stored) in the second sampling capacitor Cs2.

The pixel voltage VPIX may be applied to a first terminal of the second driving transistor DX2, and a second terminal of the second driving transistor DX2 may be connected to the first selection transistor SX1. The second driving transistor DX2 may amplify and output a change in potential change at the second node N2.

The first terminal of the first selection transistor SX1 may be connected to the second driving transistor DX2, and the second terminal of the first selection transistor SX1 may be connected to the column line CL. The first selection transistor SX1 may be turned on or turned off in response to the first selection control signal SEL1.

When the pixel array PXa operates in the global shutter mode, the first selection transistor SX1 may be turned on during the readout period of the pixel PXa, and output, as the pixel signal PXS, an output, e.g., the reset voltage RST or the image voltage SIG, of the second driving transistor DX2 to the column line CL.

For example, when the first selection transistor SX1 is in an ON state, the first sampling transistor SMP1 is in an ON state, and the second sampling transistor SMP2 is in an OFF state, then the reset voltage RST sampled in the first sampling capacitor Cs1 may be output as the pixel signal PXS, and when the second selection transistor SX is in an ON state, the second sampling transistor SMP2 is in an ON state, and the first sampling transistor SMP1 is in an OFF state, then the image voltage SIG stored in the second sampling capacitor Cs2 may be output as the pixel signal PXS.

Referring to FIG. 4B, the pixel PXb may include a photodiode PD and a pixel signal generating circuit PSCb (also referred to as a pixel circuit). Compared to FIG. 4A, the pixel signal generating circuit PSCb may further include a second selection transistor SX2.

A first terminal of the second selection transistor SX2 may be connected to the first node N1, and a second terminal may be connected to the column line CL. The second selection transistor SX2 may be turned on or off in response to the second selection control signal SEL2.

The pixel PXb may selectively operate in either a global shutter mode or a rolling shutter mode. When operating in the rolling shutter mode, the second selection transistor SX2 may be turned on during a readout period of the pixel PXb and output, as the pixel signal PXS, an output, e.g., the reset voltage RST or the image voltage SIG, of the first driving transistor DX1 to the column line CL. When operating in the rolling shutter mode, the first precharge selection transistor PSX1, the first and second sampling transistors SMP1 and SMP2, and the first selection transistor SX1 may be turned off. When the pixel PXb operates in the global shutter mode, the second selection transistor SX2 may be turned off, and the first precharge selection transistor PSX1, the first and second sampling transistors SMP1 and SMP2, and the first selection transistor SX1 may operate as described above with reference to FIG. 4A.

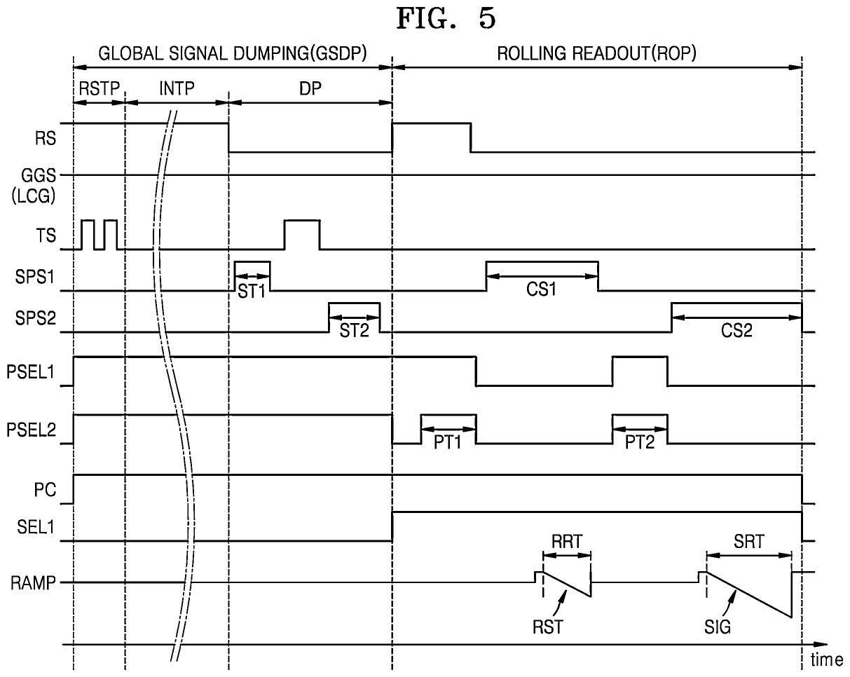

FIG. 5 is a timing diagram illustrating pixel control signals and a ramp signal provided to a pixel when an image sensor operates in the global shutter mode according to an embodiment. FIG. 5 illustrates the pixel control signals provided to the pixel PXa of FIG. 4A, such as the reset signal RS, the conversion gain control signal CGS, the transmission control signal TS, the first sampling signal SPS1, the second sampling signal SPS2, the first precharge selection signal PSEL1, the second precharge selection signal PSEL2, the precharge signal PC, the first selection signal SEL1, and a ramp signal RAMP. The conversion gain control signal CGS may be at a high level, and accordingly, the pixel PXa may operate in a low conversion gain mode.

Referring to FIGS. 5 and 4A, the transmission control signal TS may be toggled during a reset period RSTP of the global signal dumping period GSDP. As the transmission control signal TS is toggled, the charges accumulated in the photodiode PD may be removed. In other words, the pixel PXa may be shuttered. As shown, the transmission control signal TS may be toggled twice, and accordingly, the pixel PXa may perform double shuttering. However, aspects of the inventive concept are not limited thereto, and the transmission control signal TS may be toggled once.

Furthermore, the reset control signal RS and the gain control signal CGS may be maintained at a high level, and the reset transistor RX may be turned on in response to the high level reset signal RS, thereby resetting (or initializing) the floating diffusion node FD. For example, the floating diffusion node FD may be reset to the pixel voltage VPIX.

Photocharges may be generated and accumulated in the photodiode PD during the integration period INTP, and based on the pixel control signals shown in the dumping period DP after the integration period INTP, the reset voltage and the image voltage may be sampled (stored) in the first sampling capacitor Cs1 and the second sampling capacitor Cs2, respectively. A reset voltage may be sampled in the first sampling capacitor Cs1 in response to toggling of the first sampling control signal SPS1 during a first sampling period ST1. Thereafter, the charges generated in the photodiode PD are transmitted and accumulated in the floating diffusion node FD in response to the toggling of the transmission control signal TS, and, during the second sampling period ST1, in response to toggling of the second sampling control signal SPS2, an image voltage corresponding to the amount of charges of the floating diffusion node FD may be sampled in the second sampling capacitor Cs2.

During the readout period ROP, the reset voltage and the image voltage sampled in the first sampling capacitor Cs1 and the second sampling capacitor Cs2 may be read out.

During a first precharge time PT1 and a second precharge time PT2, in response to the high-levels of the first precharge selection signal PSEL1 and the second precharge selection signal PSEL2, the first precharge selection transistor PSX1 and the second precharge selection transistor PSX2 may be turned on and the second node N2 may be precharged based on the first voltage indicating a reset level of the floating diffusion node FD. Here, precharging the second node N2 may have the same meaning as resetting the second node N2.

During each of the first charge sharing (i.e., output) period CS1 and the second charge sharing (i.e., output) period CS2, the first sampling transistor SMP1 and the second sampling transistor SMP2 may be turned on in response to the high-level first sampling signal SPS1 and the second sampling signal SPS2 to output the reset voltage and the image voltage sampled in the first sampling capacitor Cs1 and the second sampling capacitor Cs2, respectively.

During a reset readout time RRT, the readout circuit (140 in FIG. 1) may compare the ramp signal RAMP with the pixel signal PXS, i.e., the reset voltage RST, output through the column line CL and convert the reset voltage RST into a reset value, which is a digital value, based on a comparison result.

During an image readout time SRT, the readout circuit (140 in FIG. 1) may compare the ramp signal RAMP with the pixel signal PXS, i.e., the image voltage SIG, output through the column line CL. Accordingly, the image voltage SIG may be converted into a digital image value. Accordingly, the readout operation of one row of pixels PXa of the pixel array (110 in FIG. 1) operating in the global shutter mode may be completed.

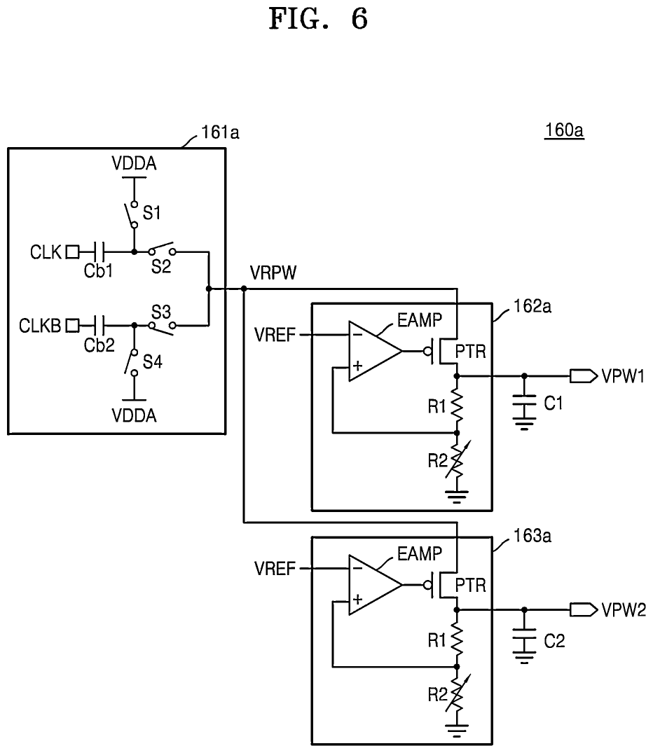

FIG. 6 is a circuit diagram illustrating another voltage generator 160a according to an embodiment. The voltage generator 160a of FIG. 6 may be applied as the voltage generator 160 of FIG. 1. Accordingly, the description given above may be applied to the present embodiment.

Referring to FIG. 6, the voltage generator 160a may include a charge pump circuit 161a, a first voltage regulator circuit 162a, and a second voltage regulator circuit 163a. The charge pump circuit 161a may be applied as the voltage conversion circuit 160 in FIG. 2.

The charge pump circuit 161a may include a plurality of boosting capacitors, e.g., a first boosting capacitor Cb1 and a second boosting capacitor Cb2, and a plurality of switches, e.g., first to fourth switches S1 to S4. The switches may be implemented as an N-channel metal oxide semiconductor (NMOS) transistor, a P-channel metal oxide semiconductor (PMOS) transistor, a complementary metal-oxide semiconductor (CMOS) transistor, or a transmission gate. The charge pump circuit 161a is not limited to the illustrated circuit and may be implemented variously.

The switches may charge the boosting capacitors Cb1 and Cb2 with an input voltage, e.g., an analog power supply voltage VDDA, based on clock signals CLK and CLKB, boost the voltage of the boosting capacitors Cb1 and Cb2 to generate a charge pump voltage, and output the charge pump voltage as a reference power supply voltage VRPW.

The first voltage regulator 162a may receive the reference power supply voltage VRPW from the charge pump circuit 161a and regulate the reference power supply voltage VRPW based on the reference voltage VREF to generate the first power supply voltage VPW1. The reference voltage VREF may be a voltage generated in a band gap reference circuit.

In an embodiment, the first voltage regulator 162a may be implemented as a low dropout LDO regulator. The first voltage regulator 162a may include an error amplifier EAMP, a pass transistor PTR, a first resistor R1, and a second resistor R2. In an embodiment, the second resistor R2 may be a variable resistor. The first power supply voltage VPW1 output from the pass transistor PTR may be distributed to the first resistor R1 and the second resistor R2, and the error amplifier EAMP may compare the distributed voltage with a reference voltage VREF, amplify a comparison result, and control the pass transistor PTR based on an amplified signal. Accordingly, the first voltage regulator 162a may regulate the reference power supply voltage VRPW based on the reference voltage VREF to generate the first power supply voltage VPW1 at the target level. The first capacitor C1 may be charged based on the first power supply voltage VPW1, and the first capacitor C1 may reduce the voltage fluctuation of the first power supply voltage VPW1.

The second voltage regulator 163a may receive the reference power supply voltage VRPW from the charge pump circuit 161a and regulate the reference power supply voltage VRPW based on the reference voltage VREF to generate the second power supply voltage VPW2. The second capacitor C2 may be charged based on the second power supply voltage VPW1, and the second capacitor C2 may reduce the voltage fluctuation of the second power supply voltage VPW2. A voltage level of the second power supply voltage VPW2 may be the same as a voltage level of the first power supply voltage VPW1. Components and operations of the second voltage regulator 163a may be the same as those of the first voltage regulator 162a. Therefore, redundant descriptions thereof are omitted.

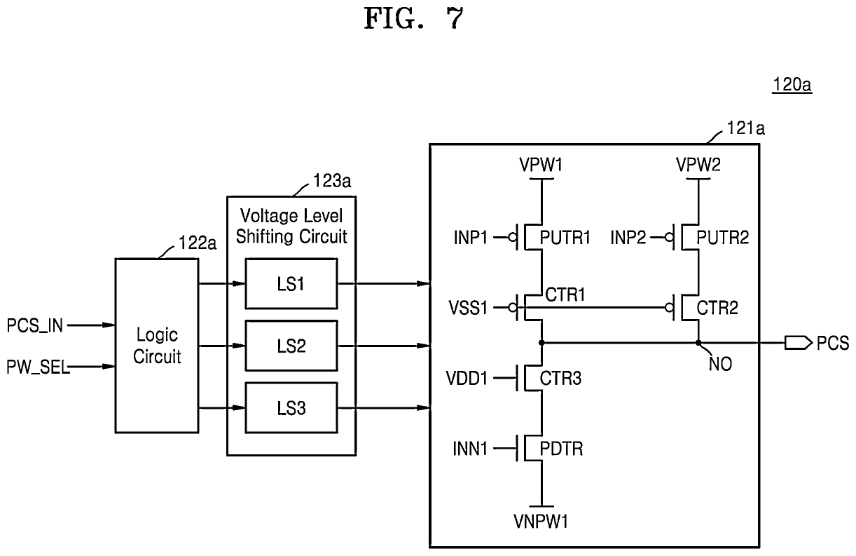

FIG. 7 illustrates a row driver 120a according to an embodiment.

The row driver 120a of FIG. 7 may be applied to the row driver 120 of FIG. 1. Accordingly, the description of the row driver 120 given above may be applied to the present embodiment.

Referring to FIG. 7, the row driver 120a may include a driver 121a, a logic circuit 122a, and a voltage level shifting circuit 123a.

The logic circuit 122a may generate a first input signal INP1, a second input signal INP2, and a third input signal INN1, based on a power selection signal PW_SEL and a pixel control input signal PCS_IN. The first input signal INP1, the second input signal INP2, and the third input signal INN1 output from the logic circuit 122a may have a logic level (e.g., a low voltage level). The voltage levels of the first input signal INP1, the second input signal INP2, and the third input signal INN1 may be shifted in the voltage level shifting circuit 123a.

For example, the voltage level shifting circuit 123a may include first to third level shifters LS1, LS2, and LS3. The first level shifter LS1 may shift a first logic level (e.g., logic low) of the first input signal INP1 to the third power supply voltage VNPW1 and a second logic level (e.g., logic high) to the first power supply voltage VPW1. The second level shifter LS2 may shift a first logic level of the second input signal INP2 to the third power supply voltage VNPW1 and a second logic level to the second power supply voltage VPW2. The third level shifter LS3 may shift a first logic level of the third input signal INN1 to the third power supply voltage VNPW1 and shift a second logic level to the first power supply voltage VPW1 or the second power supply voltage VPW2. The first input signal INP1, the second input signal INP2, and the third input signal INN1 shifted in voltage level may be provided to the driver 121a.

The driver 121a may include a first pull-up transistor PUTR1, a second pull-up transistor PUTR2, a pull-down transistor PDTR, and first to third control transistors CTR1 to CTR3. The first pull-up transistor PUTR1, the second pull-up transistor PUTR2, the pull-down transistor PDTR, and the first to third control transistors CTR1 to CTR3 may be implemented as PMOS transistors or NMOS transistors. In the embodiment illustrated in FIG. 7, the first and second pull-up transistors PUTR1 and PUTR2 and the first and second control transistors CTR1 and CTR2 may be implemented as PMOS transistors and the pull-down transistor PDTR and the third control transistor CTR3 may be implemented as NMOS transistors.

The first and second control transistors CTR1 and CTR2 may be turned on based on a first control voltage VSS1. The third control transistor CTR3 may be turned on based on a second control voltage VDD1. The first to third control transistors CTR1, CTR2, and CTR3 may prevent an excessively high voltage from being applied between gate terminals and source terminals of the first and second pull-up transistors PUTR1 and PUTR2 and the pull-down transistor PDTR respectively connected to the first to third control transistors CTR1, CTR2, and CTR3.

The first pull-up transistor PUTR1 may be turned on in response to the first input signal INP1 and output the first power supply voltage VPW1. The first power supply voltage VPW1 may be provided to an output node NO. The second pull-up transistor PUTR2 may be turned on in response to the second input signal INP2 and output the second power supply voltage VPW2. The second power supply voltage VPW2 may be provided to the output node NO. The first pull-up transistor PUTR1 and the second pull-up transistor PUTR2 may be used selectively. The first pull-up transistor PUTR1 may operate during the first period, and the second pull-up transistor PUTR2 may operate during the second period.

The pull-down transistor PDTR may be turned on in response to the third input signal INN1 and output the third power supply voltage VNPW1. The third power supply voltage VNPW1 may be provided to the output node NO. A voltage level of the third power supply voltage VNPW1 may be lower than voltage levels of the first power supply voltage VPW1 and the second power supply voltage VPW2. In an embodiment, the third power supply voltage VNPW1 may be a ground voltage.

The pull-down transistor PDTR may operate during the first period and the second period. Accordingly, the driver 121a may generate the pixel control signal PCS based on the first power supply voltage VPW1 and the third power supply voltage VNPW1 during the first period and generate the pixel control signal PCS based on the second power supply voltage VPW2 and the third power supply voltage VNPW1 during the second period. For example, when the pixel control signal PCS is toggled, a low level signal may be generated based on the third power supply voltage VNPW1, and a high level signal may be generated based on the first power supply voltage VPW1 during the first period; a low level signal may be generated based on the third power supply voltage VNPW1, and a high level signal may be generated based on the second power supply voltage VPW2 during the second period. For example, the driver 121a may drive the pixels (PX in FIG. 1) based on the first power supply voltage VPW1 and the third power supply voltage VNPW1 during the first period and drive the pixels based on the second power supply voltage VPW2 and the third power supply voltage VNPW1 during the second period.

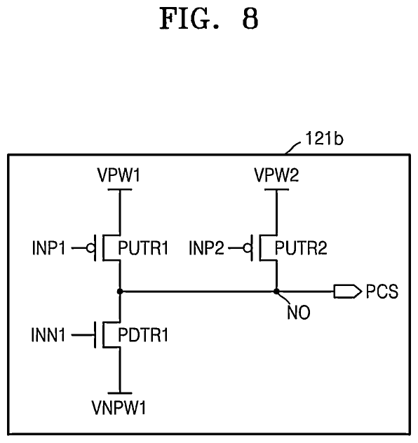

FIG. 8 is a circuit diagram illustrating a driver 121b according to an embodiment.

Referring to FIG. 8, the driver 121b may include first and second pull-up transistors PUTR1 and PUTR2 and a pull-down transistor PDTR1. Compared to the driver 121a of FIG. 7, the driver 121b does not include the first to third control transistors CTR1 to CTR3, and the first and second pull-up transistors PUTR1 and PUTR2 and the pull-down transistor PDTR1 may be directly connected to the output node NO. The operations of the first and second pull-up transistors PUTR1 and PUTR2 and the pull-down transistor PDTR1 are the same as those described above with reference to FIG. 7, so redundant descriptions thereof are omitted.

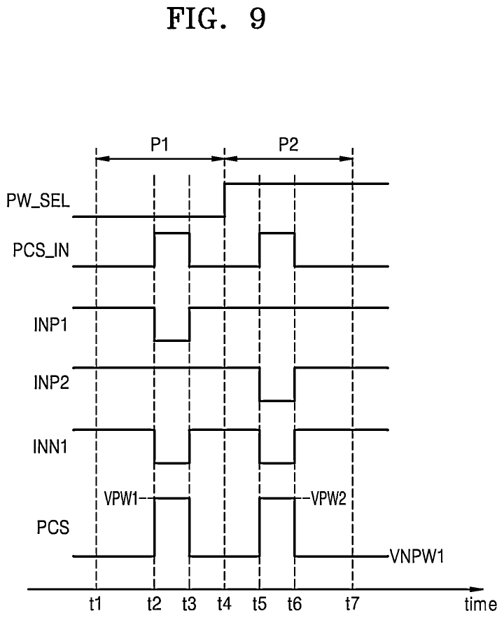

FIG. 9 illustrates a timing diagram of the row driver 120a according to an embodiment. FIG. 9 is a timing diagram of signals of the row driver 120a of FIG. 7.

Referring to FIG. 9, the power selection signal PW_SEL may be at a low level during the first period P1 (time t1 to t4) and may be at a high level during the second period P2 (time t4 to t7) (or vice versa).

The pixel input signal PCS_IN may be toggled during each of the first period P1 and the second period P2. For example, the pixel input signal PCS_IN may transition from a low level to a high level at time t2 and may transition from a high level to a low level at time t3. Accordingly, the pixel input signal PCS_IN may be toggled during the first period P1. The pixel input signal PCS_IN may transition from a low level to a high level at time t5 and may transition from a high level to a low level at time t6. Accordingly, the pixel input signal PCS_IN may be toggled during the second period P2.

When the power selection signal PW_SEL is at a low level, the logic circuit 122a may generate the first input signal INP1 and the third input signal INN1 based on the pixel input signal PCS_IN, and when the power selection signal PW_SEL is at a high level, the logic circuit 122a may generate the second input signal INP2 and the third input signal INN1 based on the pixel control input signal PCS_IN. In an embodiment, default levels of the first input signal INP1, the second input signal INP2, and the third input signal INN1 may be set to a low level. In the first period P1, the power selection signal PW_SEL is at a low level, the first input signal INP1 and the third input signal INN1 may be toggled based on the pixel control input signal PCS_IN. In the first period, the first input signal INP1 and the third input signal INN1 may have levels opposite to that of the pixel control input signal PCS_IN. In the second period, the power selection signal PW_SEL is at a high level, the second input signal INP2 and the third input signal INN1 may be toggled based on the pixel input signal PCS_IN. In the second period, the second input signal INP2 and the third input signal INN1 may have levels opposite to that of the pixel control input signal PCS_IN.

In the driver (121a in FIG. 7), the first pull-up transistor PUTR1 may be turned on based on the low-level first input signal INP1 at time t2 to time t3 and output the first power supply voltage VPW1 as the pixel control signal PCS. The second pull-up transistor PUTR2 may be turned on based on the low-level second input signal INP2 at time t5 to time t6 and output the second power supply voltage VPW2 as the pixel control signal PCS. Also, during the remaining period, e.g., at time t1 and time t2, at time t3 to time t5, and at time t6 to time t7, the pull-down transistor PDTR may be turned on based on the high level third input signal INN1 and output the third power supply voltage VNPW1 as the pixel control signal PCS.

In an embodiment, the pixel control signal PCS may be the transmission control signal (TS in FIG. 4A). In an embodiment, the first period P1 and the second period P2 may be included in the reset period (RSTP in FIG. 5). Double shuttering may be performed as the transmission control signal TS is toggled twice during the reset period RSTP. The first period P1 may be a period during which the transmission control signal TS is toggled for the first time, and the second period P2 may be a period during which the transmission control signal TS is toggled for the second time.

In an embodiment, the transmission control signal TS may be toggled during the reset period RSTP, and thereafter, during the dumping period, the transmission control signal TS may be toggled for the transmission transistor TX to transmit charges generated by the photodiode PD to the floating diffusion node FD.

If the integration period INTP between the reset period RSTP and the dumping period DP is short, a period during which the transmission control signal TS is toggled in the reset period RSTP and then the transmission control signal TS is toggled in the dumping period DP may be short. The row driver 120a may generate the pixel control signal PCS using the first power supply voltage VPW1 and the second power supply voltage VPW2 in a time-division manner, so that the sameness of the pixel control signal PCS may be maintained although the pixel control signal PCS is toggled multiple times during a short period.

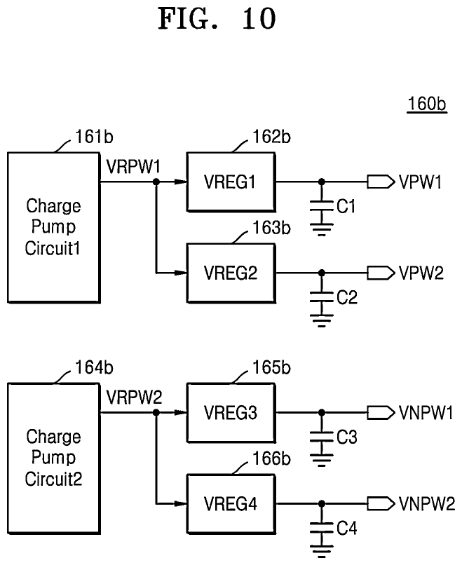

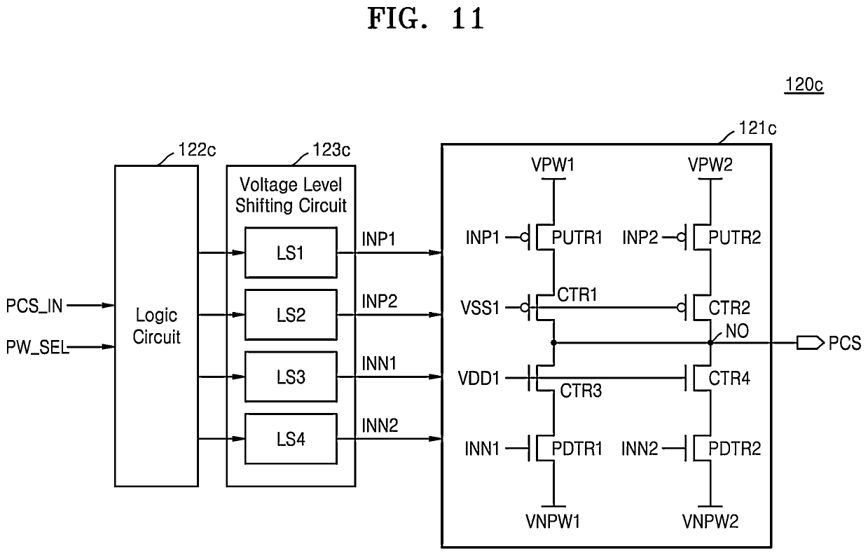

FIG. 10 is a block diagram illustrating a voltage generator 160b according to an embodiment.

Referring to FIG. 10, the voltage generator 160b may include a first charge pump circuit 161b, a second charge pump circuit 164b, a first voltage regulator circuit 162b, a second voltage regulator circuit 163b, a third voltage regulator circuit 165b, and a fourth voltage regulator circuit 166b. The first to fourth capacitors C1 to C4 may be connected to outputs of the first to fourth voltage regulators 162b, 163b, 165b, and 166b, respectively.

In an embodiment, the capacitance of the first capacitor C1 may be the same as the capacitance of the second capacitor C2, and the capacitance of the third capacitor C3 may be the same as the capacitance of the fourth capacitor C4. In an embodiment, the capacitance of the first capacitor C1 may be different from the capacitance of the second capacitor C2, and the capacitance of the third capacitor C3 may be the same as the capacitance of the fourth capacitor C4. The capacitance of the first capacitor C1 may be greater than the capacitance of the second capacitor C2. For example, the capacitance of the first capacitor C1 may be ten times or more of the capacitance of the second capacitor C2. In an embodiment, the capacitance of the first capacitor C1 may be the same as the capacitance of the second capacitor C2, and the capacitance of the third capacitor C3 may be different from the capacitance of the fourth capacitor C4. The capacitance of the third capacitor C3 may be greater than the capacitance of the fourth capacitor C4. For example, the capacitance of the third capacitor C3 may be ten times or more of the fourth capacitor C4. In an embodiment, the capacitance of the first capacitor C1 may be different from the capacitance of the second capacitor C2, and the capacitance of the third capacitor C3 may be different from the capacitance of the fourth capacitor C4.

The first charge pump circuit 161b may generate a first reference power supply voltage VRPW1 based on an input voltage, and the second charge pump circuit 164b may generate a second reference power supply voltage VRPW2 based on an input voltage. A voltage level of the second reference power supply voltage VRPW2 may be lower than a voltage level of the first reference power supply voltage VRPW1. In an embodiment, the second reference power supply voltage VRPW2 may have a negative voltage level.

The operations of the first charge pump circuit 161b, the first voltage regulator circuit 162b, and the second voltage regulator circuit 163b are the same as those of the first charge pump circuit 161a, the first voltage regulator circuit 162b, and the second voltage regulator circuit 163a described above with reference to FIG. 6, so a redundant description is omitted.

The third voltage regulator circuit 165b may regulate the second reference power supply voltage VRPW2 provided from the second charge pump circuit 164b to generate the third power supply voltage VNPW1, and the fourth voltage regulator circuit 166b may regulate the second reference power supply voltage VRPW2 provided from the second charge pump circuit 164b to generate the fourth power supply voltage VNPW2. A voltage level of the third power supply voltage VNPW1 may be the same as a voltage level of the fourth power supply voltage VNPW2. In an embodiment, the third power supply voltage VNPW1 and the fourth power supply voltage VNPW2 may have a negative voltage level.

FIG. 11 illustrates a row driver 120c according to an embodiment.

The row driver 120c of FIG. 11 may be applied to the row driver 120 of FIG. 1. Accordingly, the description of the row driver given above may be applied to the present embodiment.

Referring to FIG. 11, the row driver 120c may include a driver 121c, a logic circuit 122c, and a voltage level shifter 123c.

The logic circuit 122c may generate the first input signal INP1, the second input signal INP2, the third input signal INN1, and the fourth input signal INN2 based on the power selection signal PW_SEL and the pixel control input signal PCS_IN. Voltage levels of the first input signal INP1, the second input signal INP2, the third input signal INN1, and the fourth input signal INN2 output from the logic circuit 122c may be shifted based on respectively corresponding voltage levels in the voltage level shifting circuit 123c. For example, the voltage level shifting circuit 123c may include first to fourth level shifters LS1 to LS4, and the first to fourth level shifters LS1 to LS4 may shift levels of the first input signal INP1, the second input signal INP2, the third input signal INN1, and the fourth input signal INN2, respectively. The first input signal INP1, the second input signal INP2, the third input signal INN1, and the fourth input signal INN2 having shifted voltage levels may be provided to the driver 121c.

The driver 121c may include a first pull-up transistor PUTR1, a second pull-up transistor PUTR2, a first pull-down transistor PDTR1, a second pull-down transistor PDTR2, and first to fourth control transistors CTR1 to CTR4. The first pull-up transistor PUTR1, the second pull-up transistor PUTR2, the first pull-down transistor PDTR1, the second pull-down transistor PDTR2, and the first to third control transistors CTR1 to CTR3 may be implemented as PMOS transistors or NMOS transistors. In the embodiment illustrated in FIG. 11, the first and second pull-up transistors PUTR1 and PUTR2 and the first and second control transistors CTR1 and CTR2 may be implemented as PMOS transistors and the first and second pull-down transistors PDTR1 and PDTR2 and the third and fourth control transistors CTR3 and CTR4 may be implemented as NMOS transistors.

The first and second control transistors CTR1 and CTR2 may be turned on based on the first control voltage VSS1. The third and fourth control transistors CTR3 and CTR4 may be turned on based on the second control voltage VDD1. In an embodiment, the driver 121c may not include the first to fourth control transistors CTR1 to CTR4, and the first pull-up transistor PUTR1, the second pull-up transistor PUTR2, the first pull-down transistor PDTR1, and the second pull-down transistor PDTR2 may be directly connected to the output node NO.

The first pull-up transistor PUTR1 may be turned on in response to the first input signal INP1 and output the first power supply voltage VPW1. The first power supply voltage VPW1 may be provided to the output node NO. The second pull-up transistor PUTR2 may be turned on in response to the second input signal INP2 and output the second power supply voltage VPW2. The second power supply voltage VPW2 may be provided to the output node NO. The first pull-up transistor PUTR1 and the second pull-up transistor PUTR2 may be used selectively. The first pull-up transistor PUTR1 may operate during the first period, and the second pull-up transistor PUTR2 may operate during the second period.

The first pull-down transistor PDTR1 may be turned on in response to the third input signal INN1 and output the third power supply voltage. The third power supply voltage VNPW1 may be provided to the output node NO. The second pull-down transistor PDTR2 may be turned on in response to the fourth input signal INN2 and output the fourth power supply voltage VNPW2. The fourth power supply voltage VNPW2 may be provided to the output node NO.

The first pull-up transistor PUTR1 and the first pull-down transistor PDTR1 may operate during the first period, and the second pull-up transistor PUTR2 and the second pull-down transistor PDTR2 may operate during the second period. Accordingly, the driver 121c may generate the pixel control signal PCS based on the first power supply voltage VPW1 and the third power supply voltage VNPW1 during the first period and generate the pixel control signal PCS based on the second power supply voltage VPW2 and the fourth power supply voltage VNPW2 during the second period.

For example, the driver 121c may drive the pixels (PX in FIG. 1) based on the first power supply voltage VPW1 and the third power supply voltage VNPW1 during the first period and drive the pixels based on the second power supply voltage VPW2 and the fourth power supply voltage VNPW2 during the second period.

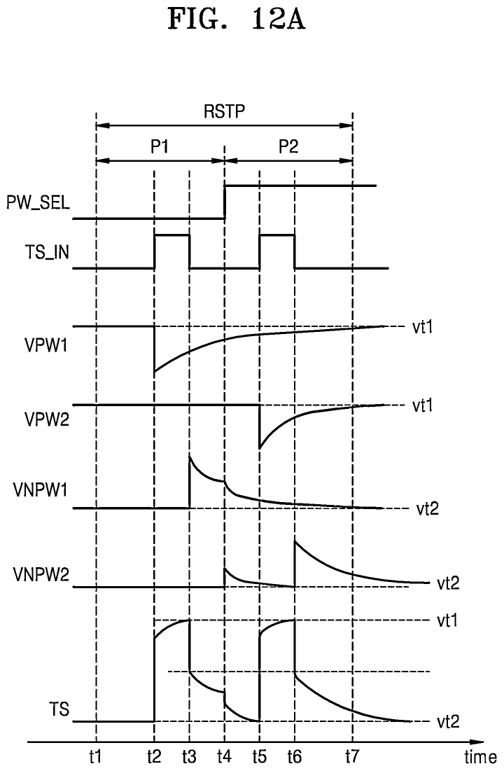

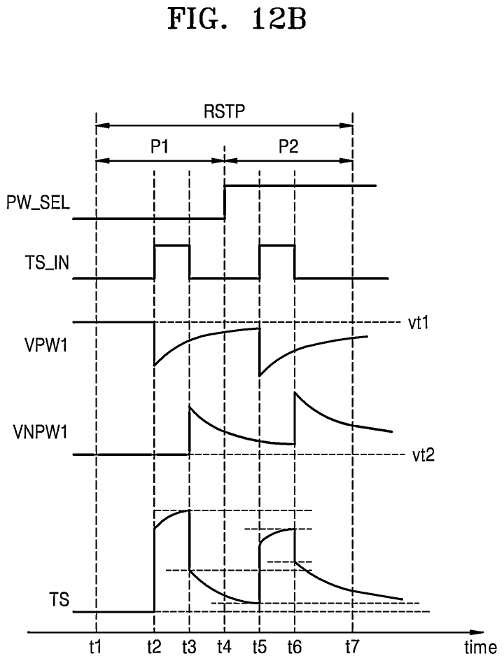

FIG. 12A is a timing diagram of the row driver 120c according to an embodiment and FIG. 12B illustrates a timing diagram of the row driver 120c according to a comparative example. FIG. 12A illustrates a timing diagram of the row driver 120c of FIG. 11, and FIG. 12B illustrates a timing diagram of a row driver according to a comparative example using the first power supply voltage VPW1 and the third power supply voltage VNPW1.

In FIGS. 12A and 12B, the first period P1 and the second period P2 may be included in the reset period RSTP, the first period P1 may be a period during which first shuttering is performed, and the second period P2 may be a period during which second shuttering is performed.

Referring to FIGS. 11 and 12A together, the row driver (120c in FIG. 11) may generate a pixel control signal, e.g., the transmission control signal TS, based on the first power supply voltage VPW1 and the third power supply voltage VNPW1 during the first period P1. A transmission control input signal TS_IN may be toggled during each of the first period P1 and the second period P2. In response to input signals, e.g., the first to fourth input signals INP1, INP2, INN1, and INN2, generated based on the power selection signal PW_SEL and the transmission control input signal TS_IN, the driver (121c in FIG. 11) may generate the transmission control signal based on the first power supply voltage VPW1 and the third power supply voltage VNPW1 during the first period P1 and may generate the transmission control signal TS based on the second power supply voltage VPW2 and the fourth power supply voltage VNPW2 during the second period P2. In other words, the driver (121c in FIG. 11) may drive the transmission transistor (TX in FIG. 4A) provided in the pixels PX based on the first power supply voltage VPW1 and the third power supply voltage VNPW1 during the first period P1 and drive the transmission transistors (TX in FIG. 4A) provided in the pixels PX based on the second power supply voltage VPW2 and the fourth power supply voltage VNPW2 during the second period P2.

During the first period P1, the power selection signal PW_SEL is at a low level, and during the second period P2, the power selection signal PW_SEL is at a high level. The transmission control input signal TS_IN may be toggled at time t2 of the first period P1, and as the transmission control input signal TS_IN transitions from a low level to a high level, the first power supply voltage VPW1 may be provided as a transmission control signal TS to the pixels PX and a voltage change, e.g., a voltage drop, occurs in the first power supply voltage VPW1 according to a driving load of the pixel array 110. The transmission control input signal TS_IN may be toggled again at time t5 of the second period P2 before the first power supply voltage VPW1 is settled to a target voltage level vt1. Here, the second power supply voltage VPW2, rather than the first power supply voltage VPW1, may be provided as the transmission control signal TS to the pixels PX. Accordingly, the voltage change in the first power supply voltage VPW1 may not affect the transmission control signal TS at time t5, and activation levels (e.g., a voltage level for turning on the transmission transistor (TX in FIG. 4A)) of the transmission control signal TS at time t2 to time t3 of the first period P1 and at time t5 to time t6 of the second period P2 may be the same.

Referring to FIG. 12B, a row driver according to a comparative example may generate a transmission control signal TS based on the first power supply voltage VPW1 and the third power supply voltage VNPW1 during the first period P1 and the second period P2.

At time t2 of the first period P1, the first power supply voltage VPW1 is provided to the pixels PX, and a voltage drop occurs in the first power supply voltage VPW1 occurs according to the driving load of the pixel array 110. The first power supply voltage VPW1 is provided again to the pixels PX at time t5 of the second period P2 before the first power supply voltage VPW1 is settled to the target voltage level vt1. As the voltage levels of the first power supply voltage VPW1 are different at time t2 and time t5, the activation levels of the transmission control signal TS are different at time t2 to time t3 and time t5 to time t6.

Subsequently, referring to FIG. 12A, as the transmission control input TS_IN transitions from a high level to a low level at time t3 of the first period P1, the third power supply voltage VNPW1 is provided as the transmission control signal TS to the pixels PX, causing a voltage change, e.g., a voltage increase, in the third power supply voltage VNPW1. Here, because the fourth power supply voltage VNPW2 is provided to the pixels as the transmission control signal TS at time t4, the voltage level of the third power supply voltage VNPW1 rapidly decreases from time t4, thereby reducing time for the third power supply voltage VNPW1 to be settled to the target level vt2.

At time t6 of the second period P2, the transmission control input TS_IN may transition from a high level to a low level again, and in this case, the fourth power supply voltage VNPW2, not the third power supply voltage VNPW1, may be applied as the transmission control signal TS to the pixels PX. Accordingly, the voltage change in the third power supply voltage VNPW1 may not affect the transmission control signal TS at time t6, and inactivation levels (e.g.,. the voltage level for turning off the transmission transistor (TX in FIG. 4A)) of the transmission control signal TS may be the same at time t3 of the first period P1 and time t6 of the second period P2.

Referring to FIG. 12B, the third power supply voltage VNPW1 is provided to the pixels PX at time t3 of the first period P1, causing a voltage increase in the third power supply voltage VNPW1. At time t6 of the second period P2, before the power supply voltage VNPW1 is settled to the target voltage level vt2, the third power supply voltage VNPW1 is provided again to the pixels PX and the voltage rises again. As the voltage levels of the third power supply voltage VPW3 are different at time t3 and time t6, the inactivation levels of the transmission control signal TS are different at time t3 and time t6.

As described above with reference to the comparative example, if the transmission control signal TS is generated based on the same power supply voltage during the first period P1 and the second period P2, that is, when the pixels are driven, the transmission control signals TS of the first period P1 and the second period P2 may not be the same due to a settling time after the voltage drop or voltage increase.

However, the row driver 120c according to an embodiment separates the power supply voltage used during the first period P1 and the second period P2, thereby maintaining the sameness of the transmission control signal TS during the first period P1 and the second period P2 and reducing the settling time of the power supply voltages. Accordingly, deterioration in the characteristics of the image sensor (110 in FIG. 1) may be reduced.

Furthermore, the first period P1 and the second period P2 are described as continuous periods in the reset time RSTP with reference to FIGS. 12A and 12B, but the embodiment is not limited thereto. For example, the first period P1 may be the reset period (RSTP in FIG. 5), and the second period P2 may be the dumping period DP. If the integration period (INTP in FIG. 5) between the reset period RSTP and the dumping period DP is shorter than the settling time of the power supply voltage, the sameness of the transmission control signal during the first period P1 and the second period P2 may be maintained by separating the power supply voltages used for the row driver 120c to generate the transmission control signal TS during the reset period RSTP and the dumping period DP.

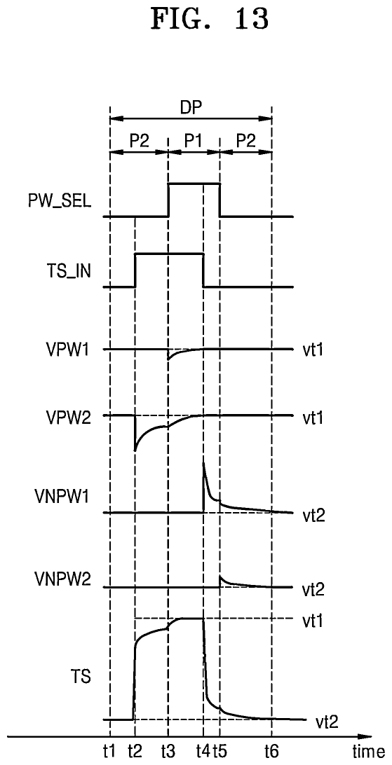

FIG. 13 is a timing diagram of a row driver according to an embodiment. FIG. 13 is a timing diagram of the row driver 120c of FIG. 11.

Referring to FIGS. 11 and 13, the row driver 120c may generate a pixel control signal, e.g., a transmission control signal TS, during the dumping period DP. The transmission control input signal TS_IN may be toggled during the dumping period DP, and in response to input signals, e.g., the first to fourth input signals INP1, INP2, INN1, and INN2, generated based on the power selection signal PW_SEL and the transmission control input signal TS_IN, the driver 120c may generate a high level of the transmission control signal TS using the first power supply voltage VPW1 and the second power supply voltage VPW2 and generate a low level of the transmission control signal TS using the third power supply voltage VNPW1 and the fourth power supply voltage VNPW2.

During the first period P1, the power selection signal PW_SEL is at a high level, and during the second period P2, the power selection signal PW_SEL is at a low level. From time t1 to t3 and from time t5 to t6 are the second period P2, and from time t3 to t5 is the first period P1.

From time t1 to t2, the fourth power supply voltage VNPW2 may be provided as the transmission control signal TS to the pixels PX according to the low level of the transmission control input signal TS_IN. At time t2, the transmission control input signal TS_IN may transition from low level to high level, and from time t2 to t3, the second power supply voltage VPW2 may be provided as the transmission control signal TS to the pixels PX. As a large amount of current is momentarily provided to the pixel array (110 in FIG. 1), a large voltage drop occurs in the second power supply voltage VPW2. At time t3, the power selection signal PW_SEL may transition from low level to high level. From time t3 to t4, the first power supply voltage VPW1 may be provided as the transmission control signal TS to the pixels PX. At time t4, the transmission control input signal TS_IN may transition from high level to low level, and at time t4 to t5, the third power supply voltage VNPW1 may be provided as the transmission control signal TS to the pixels PX. As a large amount of current is momentarily output from the pixel array (110 in FIG. 1), a large voltage increase occurs in the third power supply voltage VNPW1. At time t5, the power selection signal PW_SEL may transition from high level to low level. From time t5 to t6, the fourth power supply voltage VNPW2 may be provided as the transmission control signal TS to the pixels PX.

In this manner, when providing the transmission control signal TS, the row driver 120c may generate the high level and the low level of the transmission control signal TS respectively based on the first power supply voltage VPW1 and the third power supply voltage VNPW1 during the first period P1 and generate the high level and the low level of the transmission control signal TS respectively based on the second power supply voltage VPW2 and the fourth power supply voltage VNPW2.

In an embodiment, the capacitance of the third capacitor C3 connected to the third voltage regulator 165b that generates the third power supply voltage VNPW1 may be greater than the capacitance of the fourth capacitor C4 connected to the fourth voltage regulator 166b. When the voltage regulator momentarily sinks (or outputs) a large amount of current, such as from time t4 to t5, the capacitance of the capacitor connected to the output of the voltage regulator may be great to increase a slew rate of the transmission control signal TS. However, after the transmission control signal TS falls (or rises) to a certain level, such as from time t5 to t6, a time at which the transmission control signal TS settles to a target level, e.g., vt2, may be advanced as the capacitance of the capacitor connected to the output terminal of the voltage regulator decreases. Accordingly, at time t4 to t5, the row driver 120c may output, as the transmission control signal TS, the third power supply voltage VNPW1 generated by the third voltage regulator 165b to which the third capacitor C3 is connected, and at time t5 to t6 and at time t1 to t2, the row driver 120c may output, as the transmission control signal TS, the fourth power supply voltage VNPW2 generated by the fourth voltage regulator 166b to which the fourth capacitor C4 is connected.

In an embodiment, the capacitance of the first capacitor C1 connected to the first voltage regulator 162b that generates the first power supply voltage VPW1 may be the same as the capacitance of the second capacitor C2 connected to the second voltage regulator 163b or the capacitance of the first capacitor C1 may be less than the capacitance of the second capacitor C2.

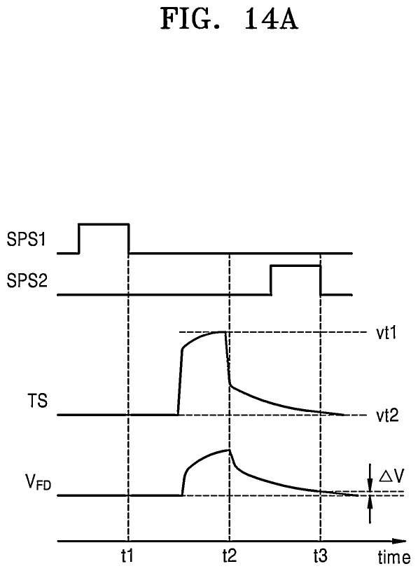

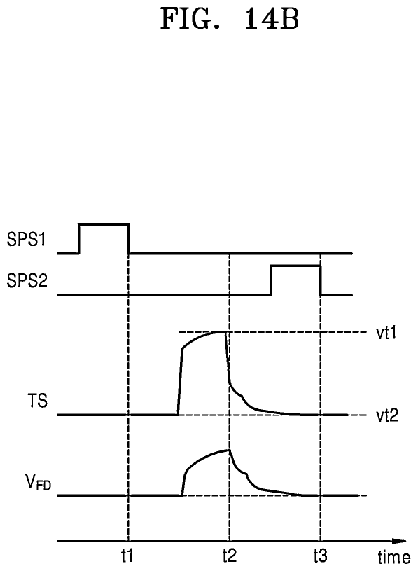

FIGS. 14A and 14B are timing diagrams of the image sensor. FIG. 14A is a timing diagram of the transmission control signal TS, the first sampling control signal SPS1, the second sampling control signal SPS2, and a voltage VED of the floating diffusion node provided to the pixel in the image sensor according to a comparative example, and FIG. 14B is a timing diagram of the transmission control signal TS, the first sampling control signal SPS1, the second sampling control signal SPS2, and the voltage VED of the floating diffusion node provided to the pixel in the image sensor according to an embodiment, which may be applied to the pixels PXa and PXb of FIGS. 4A and 4B. For convenience of description, the first sampling control signal SPS1 and the second sampling control signal SPS2 are shown to have ideal waveforms.

Referring to FIGS. 14A, 14B, and 4A, during the dumping period, in response to toggling of the first sampling control signal SPS1, the reset voltage of the floating diffusion node FD may be sampled to the first sampling capacitor Cs1, and after time t1, in response to toggling of the transmission control signal TS, the charge generated in the photo diode PD may be transmitted to and accumulated in the floating diffusion node FD. After time t1, in response to toggling of the second sampling control signal SPS2, the image voltage corresponding to the amount of charge of the floating diffusion node FD may be sampled to the second sampling capacitor Cs2.

Meanwhile, a parasitic capacitor may be formed between the gate terminal of the transmission transistor TX to which the transmission control signal TS is applied and the floating diffusion node FD, and the ON and OFF voltages (e.g. high level and low level) of the transmission control signal TS may be transmitted to the floating diffuser node FD by the parasitic capacitor. Accordingly, when the transmission control signal TS is toggled, the voltage VED of the floating diffusion node may change according to the transmission control signal TS.

As shown in FIG. 14A, after the transmission control signal TS is toggled, if the time at which the low level of the transmission control signal TS is settled to the target level vt2 is delayed (e.g., delayed until after time t3), a negative pedestal may occur in the voltage VED of the floating diffusion node. In this case, noise (a pedestal offset) may be included in the image voltage sampled to the second sampling capacitor Cs2.

However, in the image sensor according to the embodiment of FIG. 14B, as described above with reference to FIG. 13B, the row driver 120c outputs, as OFF voltages of the pixel control signal TS, the third power supply voltage VNPW1 and the fourth power supply voltage VNPW2 in a time-division manner, and thus, the pixel control signal TS may be quickly settled to the target level vt2. Accordingly, a negative pedestal does not occur in the voltage VED of the floating diffusion node.

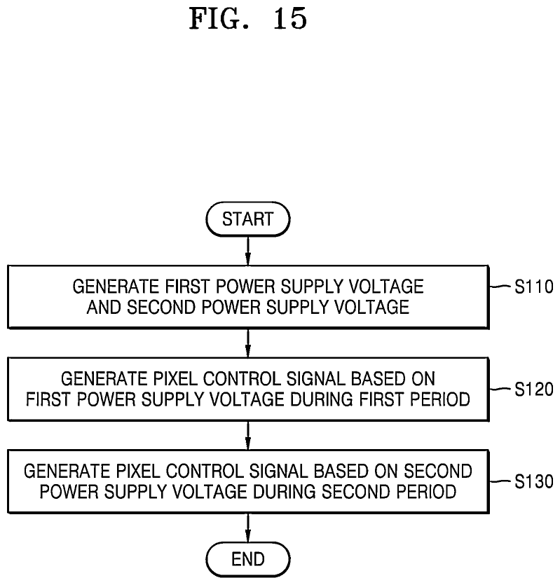

FIG. 15 is a flowchart illustrating an operating method of an image sensor according to an embodiment. The operation of FIG. 15 may be performed in the image sensor 100 of FIG. 1, and the description of the image sensor 100 may be applied to the present embodiment.

Referring to FIG. 15, a voltage generator (e.g., 160 in FIG. 1) may generate a first power supply voltage and a second power supply voltage (S110). As described above with reference to FIG. 2, the voltage generator may include a first voltage regulator circuit VREG1 162 and a second voltage regulator circuit VREG2 163, and the first voltage regulator circuit 162 and the second voltage regulator circuit 163 may generate the first power supply voltage VPW1 and the second power supply voltage VPW2, respectively.

The row driver (e.g., 120 in FIG. 1) may generate a pixel control signal based on the first power supply voltage during the first period (S120). For example, the pixel control signal may be the transmission control signal (TS in FIG. 4A). The pixel control signal may be provided to the pixels corresponding to the rows of the pixel array (e.g., 110 in FIG. 1). For example, the row driver may drive the pixels by providing a pixel control signal to the transmission transistors provided in the pixels based on the first power supply voltage during the first period.

The row driver (e.g., 120 in FIG. 1) may generate a pixel control signal based on the second power supply voltage during the second period (S130). The pixel control signal may be provided to the pixels corresponding to the rows of the pixel array. For example, the row driver may drive the pixels by providing a pixel control signal to the transmission transistors provided in the pixels based on the second power supply voltage during the second period.

In an embodiment, the image sensor 100 may perform double shuttering, and the pixel control signal may be a transmission control signal (TS in FIG. 4A) toggled twice at the reset time RSTP according to double shuttering. The transmission control signal TS may be toggled based on the first power supply voltage during the first period and may be toggled based on the second power supply voltage during the second period.

In an embodiment, the first period may be included in the reset period RSTP, and the second period may be included in the dumping period DP. The transmission control signal TS may be toggled based on the first power supply voltage and may be toggled based on the second power supply voltage during the reset period.

In an embodiment, in operation S110, the voltage generator may generate a third power supply voltage related to the first power supply voltage and a fourth power supply voltage related to the second power supply voltage. For example, the first power supply voltage and the second power supply voltage may correspond to logic high of the pixel control signal, and the third power supply voltage and the fourth power supply voltage may correspond to logic low of the pixel control signal.

In operation S120, the row driver may generate a pixel control signal based on the first power supply voltage and the third power supply voltage and provide the generated pixel control signal to the pixels, and in operation S130, the row driver may generate a pixel control signal based on the second power supply voltage and the fourth power supply voltage and provide the generated pixel control signal to the pixels.

In this manner, the image sensor may generate the pixel control signal by using a plurality of power supply voltages in a time-division manner. Accordingly, even if the driving burden increases, the sameness of the pixel control signal over time may be maintained.

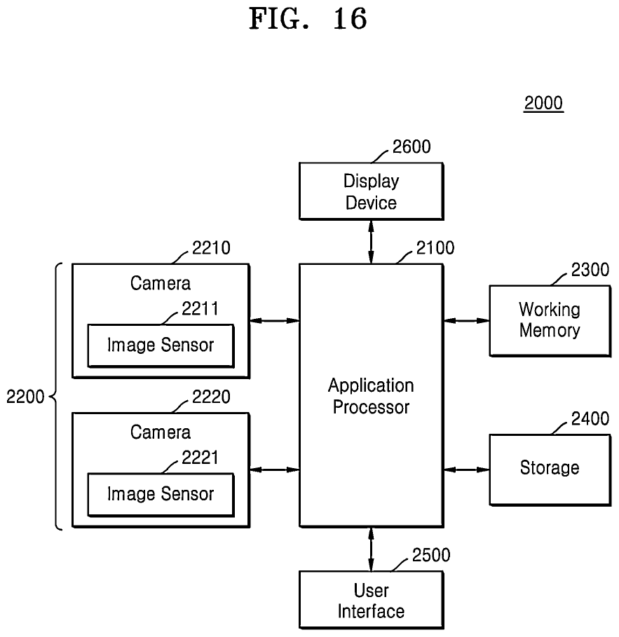

FIG. 16 is a block diagram illustrating an electronic device 2000 including an image sensor according to an embodiment. The electronic device 2000 of FIG. 16 may be a portable terminal.

Referring to FIG. 16, the electronic device 2000 may include an application processor 2100, a camera module 2200, a display device 2600, a working memory 2300, a storage 2400, and a user interface 2500. The electronic device 2000 may further include other general-purpose components, such as a communication module, a sensor module, etc.

The application processor 2100 may be implemented as a system-on-chip (SoC) that controls an overall operation of the electronic device 2000 and runs an application program, operating system, etc. The application processor 2100 may provide image data provided from the camera module 2200 to the display device 2600 or store the image data in the storage 2400. In an embodiment, the application processor 2100 may include an image processing circuit and may perform image processing, such as image quality adjustment, data format change, and HDR processing on the image data received from the camera module 2200.

The camera module 2200 may include a plurality of cameras, e.g., a first camera 2210 and a second camera 2220. The first camera 2210 and the second camera 2210 may include image sensors 2211 and 2221, respectively. At least one of the first image sensor 2211 and the second image sensor 2221 may be implemented as the image sensor 100 described above with reference to FIGS. 1 to 15. At least one of the first image sensor 2211 and the second image sensor 2221 may operate according to the global shutter method or may operate according to the global shutter method or the rolling shutter method depending on a selected mode. When at least one of the first image sensor 2211 and the second image sensor 2221 operates according to the global shutter method, the row driver may generate a pixel control signal using a plurality of power supply voltages having the same voltage level in a time-division manner.

At least one of the first image sensor 2211 and the second image sensor 2221 may operate according to a global shutter method (a global shutter mode). The row driver provided in the image sensor may generate a pixel control signal by using a plurality of power supply voltages in a time-division manner. Accordingly, the sameness of the pixel control signal may be maintained for a plurality of periods, a settling time of the power supply voltages may be reduced, and a deterioration of image quality of image data may be reduced.

The working memory 2300 may be implemented as volatile memory, such as dynamic random access memory (DRAM) and static random access memory (SRAM), or non-volatile resistive memory, such as ferroelectric random access memory (FeRAM), resistive random access memory (RRAM), or phase-change random access memory (PRAM). The working memory 2300 may store programs and/or data that the application processor 2100 processes or executes.

The storage 2400 may be implemented as a non-volatile memory device, such as NAND flash or resistive memory. For example, the storage 2400 may be provided as a memory card (multi-media card (MMC), embedded multi-media card (eMMC), SD, micro SD), etc. The storage 2400 may store image data provided from the camera 2200.

The user interface 2500 may be implemented with various devices capable of receiving user input, such as a keyboard, a curtain key panel, a touch panel, a fingerprint sensor, and a microphone. The user interface 2500 may receive user input and provide a signal corresponding to the received user input to the application processor 2100.

While aspects of the inventive concept have been particularly shown and described with reference to embodiments thereof, it will be understood that various changes in form and details may be made therein without departing from the spirit and scope of the following claims.

What is claimed is:

1. An image sensor comprising:
a pixel array in which a plurality of pixels are arranged in rows and columns;
a voltage generator configured to generate a plurality of voltages including a first power supply voltage and a second power supply voltage, wherein the first power supply voltage and the second power supply voltage have a same voltage level; and
a row driver configured to generate a pixel control signal provided to the plurality of pixels based on the first power supply voltage during a first period and generate the pixel control signal based on the second power supply voltage during a second period after the first period.

2. The image sensor of claim 1, wherein the row driver includes:
a first transistor, to which the first power supply voltage is applied, providing the first power supply voltage to an output node in response to an activation level of a first input signal during the first period; and
a second transistor, to which the second power supply voltage is applied, providing the second power supply voltage to the output node in response to an activation level of a second input signal during the second period.

3. The image sensor of claim 1, wherein the voltage generator includes:
a charge pump configured to generate a reference power supply voltage based on an input voltage;
a first voltage regulator circuit configured to regulate the reference power supply voltage to generate the first power supply voltage;
a first capacitor connected to an output terminal of the first voltage regulator circuit;
a second voltage regulator circuit configured to regulate the reference power supply voltage to generate the second power supply voltage; and
a second capacitor connected to an output terminal of the second voltage regulator circuit.

4. The image sensor of claim 1, wherein the row driver includes:
a first pull-up transistor, to which the first power supply voltage is applied, operating in response to a first input signal;
a first control transistor connected between a first terminal of the first pull-up transistor and an output node;
a first pull-down transistor, to which a third power supply voltage is applied, operating in response to a second input signal;
a second control transistor connected between a first terminal of the first pull-down transistor and the output node;
a second pull-up transistor, to which the second power supply voltage is applied, operating in response to a third input signal;
a third control transistor connected between a first terminal of the second pull-up transistor and the output node;
a second pull-down transistor, to which a fourth power supply voltage is applied, operating in response to a fourth input signal; and
a fourth control transistor connected between a first terminal of the second pull-down transistor and the output node,
wherein a level of the third power supply voltage is the same as a level of the fourth power supply voltage, and a level of the third power supply voltage and a level of the fourth power supply voltage are lower than voltage levels of the first power supply voltage and the second power supply voltage.

5. The image sensor of claim 4, wherein the row driver
outputs, as the pixel control signal, the first power supply voltage or the third power supply voltage through the output node during the first period, and
outputs, as the pixel control signal, the second power supply voltage or the fourth power supply voltage through the output node during the second period.

6. The image sensor of claim 4, wherein the voltage generator includes:
a first charge pump circuit configured to generate a first reference power supply voltage based on an input voltage;
a second charge pump circuit configured to generate a second reference power supply voltage based on the input voltage, wherein a voltage level of the second reference power supply voltage is lower than a voltage level of the first reference power supply voltage;
a first voltage regulator circuit configured to generate the first power supply voltage based on the first reference power supply voltage;
a first capacitor connected to an output terminal of the first voltage regulator circuit;
a second voltage regulator circuit configured to generate the second power supply voltage based on the first reference power supply voltage;
a second capacitor connected to an output terminal of the second voltage regulator circuit;
a third voltage regulator circuit configured to generate the third power supply voltage based on the second reference power supply voltage;
a third capacitor connected to an output terminal of the third voltage regulator circuit;
a fourth voltage regulator circuit configured to generate the fourth power supply voltage based on the second reference power supply voltage; and
a fourth capacitor connected to an output terminal of the fourth voltage regulator circuit.

7. The image sensor of claim 6, wherein capacitance of the fourth capacitor is less than capacitance of the third capacitor.

8. The image sensor of claim 1, wherein each of the plurality of pixels includes:
a photodiode configured to generate a charge based on received light; and
a transmission transistor configured to transmit the charge generated by the photodiode to a floating diffusion node in response to a transmission control signal; and
a sampling circuit configured to sample a reset signal and an image signal respectively corresponding to a reset level and a signal level of the floating diffusion node,
wherein, during a global reset period and a signal dumping period, the row driver simultaneously provides the transmission control signal, as the pixel control signal, to a plurality of rows of the pixel array.

9. The image sensor of claim 8, wherein the first period and the second period are included in at least one of the global reset period and the signal dumping period.

10. The image sensor of claim 8, wherein the first period is included in the global reset period, and the second period is included in the signal dumping period.

11. An image sensor comprising:
a pixel array including a plurality of pixels arranged in rows and columns;
a voltage generating circuit configured to generate a first power supply voltage, a second power supply voltage, a third power supply voltage, and a fourth power supply voltage, wherein the first power supply voltage and the second power supply voltage have a first voltage level, and the third power supply voltage and the fourth power supply voltage have a second voltage level that is lower than the first voltage level; and
a row driver configured to generate a pixel control signal provided to the plurality of pixels based on the first power supply voltage and the third power supply voltage during a first period and generate a pixel control signal provided to the plurality of pixels based on the second power supply voltage and the fourth power supply voltage during a second period after the first period.

12. The image sensor of claim 11, wherein the row driver includes:
a first pull-up transistor, to which the first power supply voltage is applied, operating in response to a first input signal;
a first control transistor connected between a first terminal of the first pull-up transistor and an output node;
a first pull-down transistor, to which the third power supply voltage is applied, operating in response to a second input signal;
a second control transistor connected between a first terminal of the first pull-down transistor and the output node;
a second pull-up transistor, to which the second power supply voltage is applied, operating in response to a third input signal;
a third control transistor connected between a first terminal of the second pull-up transistor and the output node;
a second pull-down transistor, to which the fourth power supply voltage is applied, operating in response to a fourth input signal; and
a fourth control transistor connected between a first terminal of the second pull-down transistor and the output node,

13. The image sensor of claim 12, wherein
the first control transistor, the second control transistor, the third control transistor, and the fourth control transistor are turned on during the first period and the second period,
the first pull-down transistor and the first pull-up transistor output the first power supply voltage or the third power supply voltage as the pixel control signal during the first period, and
the second pull-down transistor and the second pull-up transistor output the second power supply voltage or the fourth power supply voltage as the pixel control signal during the second period.

14. The image sensor of claim 11, wherein the voltage generating circuit includes:
a first charge pump circuit configured to generate a first reference power supply voltage based on an input voltage;
a second charge pump circuit configured to generate a second reference power supply voltage based on the input voltage, wherein a voltage level of the second reference power supply voltage is lower than a voltage level of the first reference power supply voltage;
a first voltage regulator circuit configured to generate the first power supply voltage based on the first reference power supply voltage;
a first capacitor connected to an output terminal of the first voltage regulator circuit;
a second voltage regulator circuit configured to generate the second power supply voltage based on the first reference power supply voltage;
a second capacitor connected to an output terminal of the second voltage regulator circuit;
a third voltage regulator circuit configured to generate the third power supply voltage based on the second reference power supply voltage;
a third capacitor connected to an output terminal of the third voltage regulator circuit;
a fourth voltage regulator circuit configured to generate the fourth power supply voltage based on the second reference power supply voltage; and
a fourth capacitor connected to an output terminal of the fourth voltage regulator circuit.

15. The image sensor of claim 11, wherein the plurality of pixels operate according to a global shutter method, and the pixel control signal is provided simultaneously to the plurality of pixels.

16. The image sensor of claim 15, wherein each of the plurality of pixels includes:
a photodiode configured to change received light into a charge;
a transmission transistor configured to transmit the charge generated by the photodiode to a floating diffusion node in response to a transmission control signal; and
a sampling circuit configured to sample a reset level and a signal level of the floating diffusion node,
wherein the pixel control signal includes a transmission control signal provided to the transmission transistor.

17. An operating method of an image sensor including a pixel array including a plurality of pixels, a row driver driving the pixel array, and a voltage generating circuit providing a power supply voltage to the row driver, the operating method comprising:
generating, by the voltage generating circuit, a first power supply voltage and a second power supply voltage;
generating, by the row driver, a pixel control signal provided to the plurality of pixels corresponding to a plurality of rows of the pixel array based on the first power supply voltage during a first period; and
generating, by the row driver, the pixel control signal based on the second power supply voltage during a second period after the first period.

18. The operating method of claim 17, wherein an exposure start time of each of the plurality of pixels is the same.

19. The operating method of claim 17, wherein the first period and the second period are included in a shuttering period of the plurality of pixels.

20. The operating method of claim 17, wherein the first period is included in a shuttering period of the plurality of pixels, and the second period is included in a signal sampling period of the plurality of pixels.
